(19) United States
(12) Patent Application Publication
(10) Pub. No.: US 2025/0168403 A1
(43) Pub. Date: May 22, 2025

(54) INFORMATION PROCESSING DEVICE AND METHOD

(71) Applicant: Sony Group Corporation, Tokyo (JP)

(72) Inventors: Tsuyoshi KATO, Kanagawa (JP); Satoru KUMA, Tokyo (JP)

(73) Assignee: Sony Group Corporation, Tokyo (JP)

(21) Appl. No.: 18/839,739

(22) PCT Filed: Mar. 6, 2023
(86) PCT No.: PCT/JP2023/008231

§ 371 Date: Aug. 20, 2024

(30) Foreign Application Priority Data
Mar. 24, 2022 (JP) 2022-047951

(51) Int. Cl. H04N 19/597; G06T 17/20; H04N 19/119; H04N 19/70

(52) U.S. Cl. CPC H04N 19/597; G06T 17/20; H04N 19/119; H04N 19/70

(57) ABSTRACT

There is provided an information processing device and a method that allow for suppression of reduction in encoding efficiency while suppressing degradation in subjective image quality. A base mesh with fewer vertices than a target mesh is generated, a plurality of patches are generated by dividing the target mesh and projecting the divided parts on the base mesh, a geometry image is generated by arranging the patches on a frame image, and vertex connectivity information about the base mesh and the geometry image are encoded. The vertex connectivity information and the encoded data of the geometry image are decoded, the number of vertices of the base mesh is increased using the vertex connectivity information, the patches are reconstructed, and reconstructed vertex information is generated using the reconstructed patches. The present disclosure can be applied for example to an information processing device, an electronic apparatus, an information processing method, or a program.

### TECHNICAL FIELD

The present disclosure relates to an information processing device and method, and particularly to an information processing device and method that allow for the suppression of reduction in encoding efficiency while suppressing degradation in subjective image quality.

### BACKGROUND ART

Conventionally a mesh has been used as 3D data to represent an object in a three-dimensional shape. It has been proposed to extend VPCC (Video-based Point Cloud Compression) (see, for example, NPL 1) to compress meshes.as a mesh compressing method (see, for example, NPL 2).

### CITATION LIST

### Non Patent Literature

### NPL 1:

“ISO/IEC FDIS 23090-5 Visual Volumetric Video-based Coding and Video-based Point Cloud Compression”, ISO/IEC JTC 1/SC 29/WG 11 N19579, 2020-09-21 NPL 2: Danillo Graziosi, Alexandre Zaghetto, Ali Tabatabai, “[VPCC][EE2.6-related] Mesh Patch Data”, ISO/IEC JTC 1/SC 29/WG 7 m 55368, October 2020

### SUMMARY

### Technical Problem

However, according to the method, vertex connectivity information about mesh vertices and connections must be encoded separately for example, from geometry images, texture images. As such, there has been a risk of a drop in the encoding efficiency of the mesh. Reducing the number of vertices in the mesh could reduce the code amount for vertex connectivity information, which could, however, reduce the resolution of geometry or texture in the reconstructed mesh, so that subjective image quality could be reduced.

In the view of the foregoing, the present disclosure is directed to the suppression of reduction in encoding efficiency while suppressing degradation in subjective image quality.

### Solution to Problem

An information processing device according to one aspect of the present technology includes a base mesh generation unit configured to generate a base mesh which is 3D data that represents a three-dimensional structure of an object by vertices and connections and has a smaller number of the vertices than a target mesh, a patch generation unit configured to generate multiple patches by dividing the target mesh and projecting the divided parts on the base mesh, a geometry image generation unit configured to generate a geometry image by arranging the patches on a frame image, a meta information encoding unit configured to encode meta information including vertex connectivity information about the vertices and the connections of the base mesh, and a geometry image encoding unit configured to encode the geometry image.

An information processing method according to one aspect of the present technology includes the steps of generating a base mesh which is 3D data that represents a three-dimensional structure of an object by vertices and connections and has a smaller number of the vertices than a target mesh, generating multiple patches by dividing the target mesh and projecting the divided parts on the base mesh, generating a geometry image by arranging the patches on a frame image, encoding meta information including vertex connectivity information about the vertices and the connections of the base mesh; and encoding the geometry image.

An information processing device according to another aspect of the present technology includes a meta information decoding unit configured to decode encoded data of meta information including vertex connectivity information which is information about vertices and connections of a base mesh, a geometry image decoding unit configured to decode encoded data of a geometry image which is a frame image having a patch arranged thereon, a vertex number increasing unit configured to increase the number of vertices of the base mesh using the vertex connectivity information, a patch reconstruction unit configured to reconstruct the patch using the geometry image and the base mesh with the increased number of vertices, and a vertex information reconstruction unit configured to generate reconstructed vertex information about the vertices of the base mesh with the increased number of vertices by reconstructing three-dimensional positions of the vertices of the base mesh with the increased number of vertices using the reconstructed patch, wherein the base mesh is 3D data that represents a three-dimensional structure of an object by the vertices and the connections and has a smaller number of the vertices than a target mesh, and the patch is a divided part of the target mesh that represents the base mesh as a projection plane.

An information processing method according to another aspect of the present technology includes the steps of decoding encoded data of meta information including vertex connectivity information about vertices and connections of a base mesh, decoding encoded data of a geometry image which is a frame image having a patch arranged thereon, increasing the number of vertices of the base mesh using the vertex connectivity information, reconstructing the patch using the geometry image and the base mesh having the increased number of the vertices, and generating reconstructed vertex information about the vertices of the base mesh having the increased number of vertices by reconstructing three-dimensional positions of the vertices of the base mesh having the increased number of vertices using the reconstructed patch, wherein the base mesh is 3D data that represents a three-dimensional structure of an object by the vertices and the connections and has a smaller number of the vertices than a target mesh, and the patch is a divided part of the target mesh that represents the base mesh as a projection plane.

In an information processing device and method according to one aspect of the present technology a base mesh which is 3D data that represents a three-dimensional structure of an object by vertices and connections and has fewer vertices than a target mesh is generated, multiple patches are generated by dividing the target mesh and projecting the divided parts on the base mesh, a geometry image is generated by arranging the patches on a frame image, meta information including vertex connectivity information about the vertices and the connections of the base mesh is encoded, and a geometry image is encoded.

In an information processing device and method according to another aspect of the present technology encoded data of meta information including vertex connectivity information which is information about vertices and connections of a base mesh is decoded, encoded data of a geometry image which is a frame image having a patch arranged thereon is decoded, the number of vertices of the base mesh is increased using the vertex connectivity information, the patch is reconstructed using the geometry image and the base mesh with the increased number of vertices, and reconstructed vertex information about the vertices of the base mesh with the increased number of vertices is generated by reconstructing three-dimensional positions of the vertices of the base mesh with the increased number of vertices using the reconstructed patch.

### BRIEF DESCRIPTION OF DRAWINGS

FIG. 1 illustrates a video-based approach.

FIG. 2 illustrates a mesh.

FIG. 3 illustrates an encoding/decoding method.

FIG. 4 is a view for illustrating an example of projection planes.

FIG. 5 is a view for illustrating an example of a projection plane.

FIG. 6 illustrates an example of syntax.

FIG. 7 is a view for illustrating an example of decimation.

FIG. 8 is a view for illustrating an example of global deformation.

FIG. 9 is a view for illustrating an example of local deformation.

FIG. 10 illustrates an example of a base mesh primitive.

FIG. 11 illustrates an example of a base mesh primitive candidate.

FIG. 12 illustrates an example of syntax.

FIG. 13 illustrates an example of syntax.

FIG. 14 illustrates an example of syntax.

FIG. 15 is a view for illustrating an example of tessellation.

FIG. 16 illustrates tessellation parameters.

FIG. 17 illustrates an example of syntax.

FIG. 18 illustrates an example of syntax.

FIG. 19 is a diagram for illustrating Ad.

FIG. 20 is a diagram for illustrating Ad.

FIG. 21 is a view for illustrating patch arrangement.

FIG. 22 illustrates an example of syntax.

FIG. 23 illustrates an example of a main structure of a bit stream.

FIG. 24 illustrates an example of syntax.

FIG. 25 illustrates an example of syntax.

FIG. 26 is a block diagram of an example of a main structure of an encoding device.

FIG. 27 is a flowchart for illustrating an example of the flow of encoding processing.

FIG. 28 is a block diagram of an example of a main structure of a decoding device.

FIG. 29 is a flowchart for illustrating an example of the flow of decoding processing.

FIG. 30 is a block diagram of an example of a main structure of a computer.

### DESCRIPTION OF EMBODIMENTS

Hereinafter, modes for carrying out the present disclosure (hereinafter referred to as embodiments) will be described. The descriptions will be given in the following order.
1. Literature supporting technical content and terminology
2. Mesh compression with VPCC extension
3. Mesh compression using base mesh
4. First Embodiment (encoding device)
5. Second Embodiment (decoding device)
6. Supplement

### 1. Literature Supporting Technical Content and Terminology

The scope disclosed in the present application is not limited to the content described in embodiments and also includes the content described in NPL below and the like that were known at the time of filing and the content of other literature referred to in NPL below.
NPL 1: (see above)
NPL 2: (see above)

In other words, the content of the non-patent literature and the content of other literature referred to in the foregoing non-patent literature are also grounds for determining support requirements.

### 2. Mesh Compression with VPCC Extension

### <Point Cloud>

In conventional technology, there has been 3D data, such as point clouds, which represents a three-dimensional structure for example using point position information and attribute information.

In the case of a point cloud, for example, a stereoscopic structure (an object in a three-dimensional shape) is expressed as a group of multiple points. The point cloud includes position information (also referred to as a geometry) and attribute information (also referred to as an attribute) about each point. The attribute can include any information. For example, the attribute may include color information, reflectance information, and normal line information about each point. Thus, the point cloud has a relatively simple data structure and can represent any stereoscopic structure with sufficient accuracy by using a sufficiently large number of points.

### <VPCC>

VPCC (Video-based Point Cloud Compression) described in NPL 1 is one of the encoding technologies for such point clouds and according to the technology, point cloud data, which is 3D data representing a three-dimensional structure, is encoded using codecs for two-dimensional images.

In VPCC, the geometry and attributes of a point cloud are separated into small regions (also referred to as patches) and projected, on a patch-by-patch basis, onto a projection plane, which is a two-dimensional plane. For example, the geometry and attributes are projected on one of the six faces of a bounding box that encloses the object. The geometry and attributes projected on the projection plane are also referred to as a projected image. The patches projected on the projection plane are referred to as a patch images.

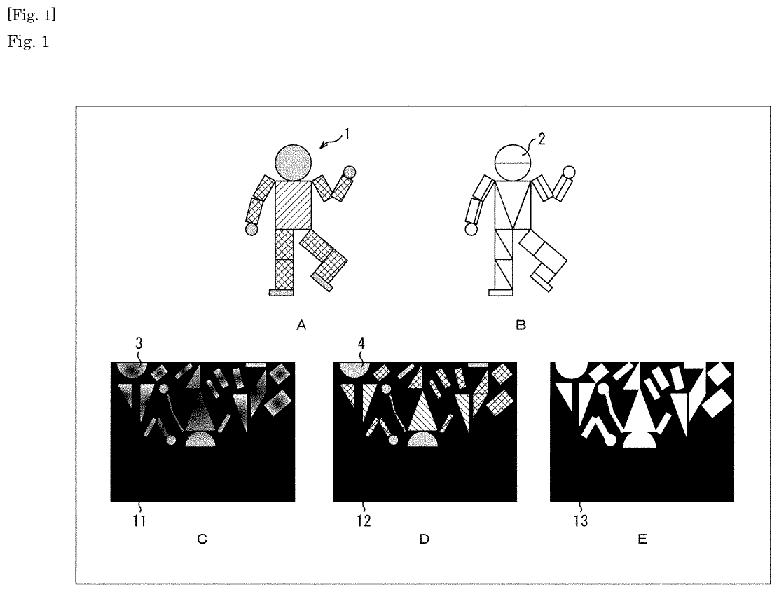

For example, the geometry of a point cloud 1, which represents an object with a three-dimensional structure shown in FIG. 1 at A, is separated into patches 2, as shown in FIG. 1 at B, which are projected onto the projection plane on a patch-by-patch basis. In other words, patch images of the geometry (a projected image for each patch) are generated. The pixel values of the patch images of the geometry each indicate the distance from the projection plane to the point (“depth value (Depth)”).

Similarly to the geometry, the attributes of point cloud 1 are separated into patches 2 and projected onto the same projection plane as the geometry on a patch-by-patch basis. In other words, patch images of the attributes with the same size and shape as the patch images of the geometry are generated. The pixel values of the attribute patch images each indicate the attributes (such as color, normal vector, and reflectance) of the point at the same position in the corresponding patch image of the geometry.

Then, the patch images generated in this manner are each arranged in a frame image (also referred to as a video frame) of a video sequence. More specifically the patch images on the projection plane are arranged on a prescribed two-dimensional plane.

For example, a frame image having a geometry patch image arranged thereon is also referred to as a geometry video frame. The geometry video frame is also referred to for example as a geometry image or a geometry map. The geometry image 11 shown in FIG. 1 at C is a frame image having a geometry patch image 3 (geometry video frame) arranged thereon. The patch image 3 corresponds to the patch 2 shown in FIG. 1 at B (the patch 2 of the geometry projected on the projection plane).

A frame image having an attribute patch image arranged thereon is also referred to as an attribute video frame. The attribute video frame is also referred to as an attribute image or an attribute map. An attribute image 12 shown in FIG. 1 at D is a frame image (attribute video frame) having an attribute patch image 4 arranged thereon. The patch image 4 corresponds to the patch 2 shown in FIG. 1 at B (i.e., a projection of the attribute patch 2 on the projection plane).

These video frames are encoded according to an encoding method for two-dimensional images such as AVC (advanced video coding) and HEVC (high efficiency video coding). In other words, the point cloud data, which is 3D data representing a three-dimensional structure, can be encoded by using codecs for two-dimensional images. In general, 2D data encoders are widely available and can be implemented less costly than 3D encoders. More specifically, by applying the video-based approach as described above, an increase in cost can be suppressed.

In the case of such a video-based approach, an occupancy image (also referred to as an occupancy map) can also be used. The occupancy image is map information indicating the presence or absence of a projection image (patch) for each of N×N pixels of a geometry video frame or an attribute video frame. For example, in the occupancy image, an area (N×N pixels) with a patch in a geometry video frame or an attribute video frame is indicated by a value “1”, whereas an area (N×N pixels) with no patches is indicated by a value “0”.

Such an occupancy image is encoded as data different from the geometry video frame or the attribute video frame and is then transmitted to the decoding side. Since a decoder can recognize whether patches are present in the area with reference to the occupancy map, the influence of noise or the like generated by encoding/decoding can be suppressed, and the point cloud can be more accurately reconstructed. If for example the depth value is changed by encoding/decoding, the decoder can ignore a depth value (avoid processing of the depth value as position information about the 3D data) in an area having no patch images with reference to the occupancy map.

For example, for the geometry image 11 in FIG. 1 at C and the attribute image 12 in FIG. 1 at D, an occupancy image 13 may be generated as shown in FIG. 1 at E. In the occupancy image 13, a white portion indicates a value “1” and a black portion indicates a value “0”.

The occupancy image can also be transmitted as a video frame, similarly to the geometry video frame and the attribute video frame. In other words, an encoding method for two-dimensional images such as AVC and HEVC is used for encoding similarly to the geometry and attributes.

More specifically as for VPCC, the geometry and attributes of a point cloud are projected on the same projection plane and arranged in the same position in the frame image. More specifically the geometry and attributes at each point are associated with each other according to the positions on the frame image.

### <Mesh>

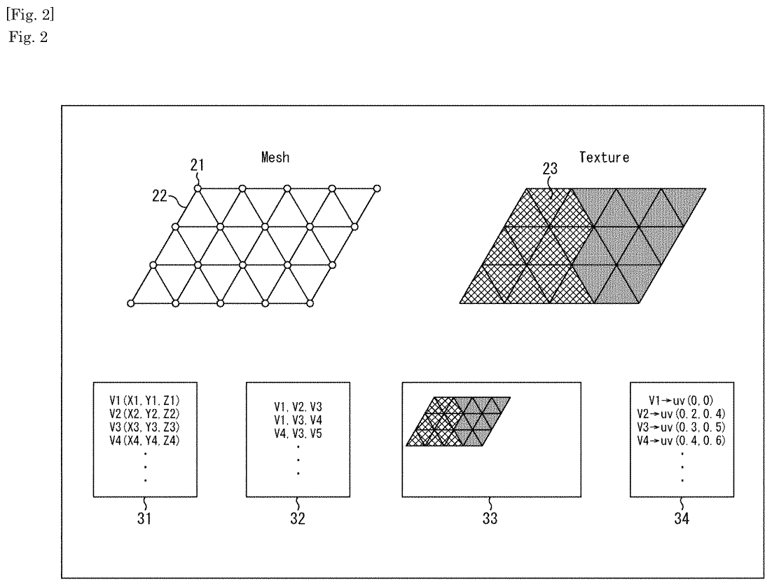

In addition to point clouds, there is another form of 3D data representing a three-dimensional structure, such as a mesh. As shown in FIG. 2, a mesh represents the surface of an object in a three-dimensional space by polygons, which are planes (polygonal) enclosed by edges 22 connecting vertices 21. The 3D data that represents the object includes the mesh and a texture 23 that is attached to each polygon, as shown in FIG. 2.

As shown in the lower part in FIG. 2, the mesh consists of vertex information 31, which is position information (3D coordinates (X, Y, Z)) about each of the vertices 21, a connectivity 32, which shows the vertices 21 and edges 22 that form each polygon, a texture image 33, which is map information about the texture 23 attached to each polygon, and a UV map 34, which shows the position of the texture corresponding to each vertex 21 in the texture image 33 (i.e., the position of each vertex 21 in the texture image 33). The UV map 34 indicates the position of each vertex by UV coordinates on the texture image 33.

Unlike VPCC described above, in the case of the mesh, the UV map 34 indicates the correspondence between each vertex 21 and the texture 23. Therefore, as shown in the example in FIG. 2, the texture image 33 is formed as map information independent from the vertex information 31 consisting of 3D coordinates of each vertex. Therefore, in the texture image 33, the texture 23 of each polygon can have its projection direction and resolution set arbitrarily.

### <Mesh Compression Using VPCC>

For example, NPL 2 proposes, as a method for compressing such a mesh, a method for compressing (encoding) the mesh by extending the VPCC described above.

When a mesh is compressed (encoded) by extending the VPCC, the texture and geometry of the mesh are separated into multiple patches and arranged in a single image and are encoded as a geometry image and a texture image, respectively using an encoding method for two-dimensional images. However, since the vertices of the mesh and connections therebetween cannot be easily identified only with the geometry image, vertex connectivity information is encoded separately. The vertex connectivity information is about the vertices and connections of the mesh. The connections refer to the connections (connectivity) between vertices in the mesh.

Therefore, the mesh encoding efficiency may be lowered because of the vertex connectivity information. In addition, as the mesh has a higher resolution, the amount of data included in the vertex connectivity information increases, which may cause a decrease in the mesh encoding efficiency.

For example, MPEG4 AFX (Animation Framework eXtension) has a technology called WSSs (Wavelet Subdivision Surfaces), which is a technology to realize a scalable function, and arbitrary LOD details can be extracted by encoding with a (one-dimensional) wavelet according to the technology. By applying the WSSs to the encoding of vertex connectivity information, the encoder may encode the vertex connectivity information at a lower resolution, and the decoder may restore the vertex connectivity information with a high resolution. This is expected to suppress the increase in the amount of encoded vertex connectivity information.

However, the WSSs is for producing a high-resolution mesh from a low-resolution mesh, and its application to compression of a mesh using VPCC is not taken into consideration. In other words, if WSSs are simply applied in the encoding of vertex connectivity information, the geometry and texture images cannot be properly accommodated, making it difficult to accurately reconstruct the mesh. Meanwhile, the number of vertices of the mesh to be encoded could be reduced to achieve a lower resolution (i.e., lower resolution in the geometry and texture images similarly to the vertex connectivity information), but in this case, the accuracy of the shape and texture of the restored mesh could be reduced, and the subjective image quality could be reduced.

### 3. Mesh Compression Using Base Mesh

### <Use of Base Mesh (#1)>

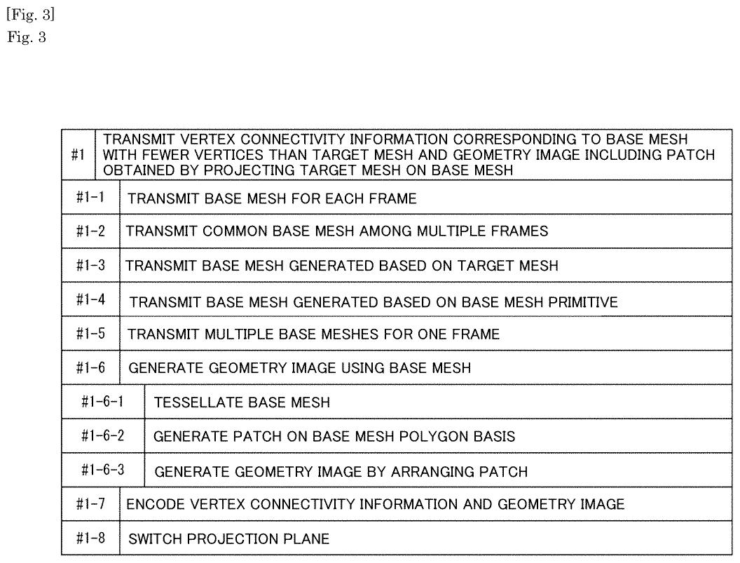

Therefore, as shown in the uppermost row of the table in FIG. 3, vertex connectivity information corresponding to a base mesh with fewer vertices than a target mesh and a geometry image including a patch on which the target mesh is projected onto the base mesh are transmitted (#1).

For example, an information processing device (e.g., an encoding device) includes a base mesh generation unit that generates a base mesh, which is 3D data representing a three-dimensional structure of an object by vertices and connections and has fewer vertices than a target mesh, a patch generation unit that generates multiple patches by dividing the target mesh and projecting the divided parts onto the base mesh, a geometry image generation unit that generates a geometry image by arranging the patches in a frame image, a meta information encoding unit that encodes meta information including vertex connectivity information about the vertices and connections of the base mesh, and a geometry image encoding unit that encodes the geometry image.

For example, an information processing method (e.g., encoding method) includes generating a base mesh, which is 3D data representing a three-dimensional structure of an object by vertices and connections and has fewer vertices than a target mesh, generating multiple patches by dividing the target mesh and projecting the divided parts onto the base mesh, generating a geometry image by arranging the patches in a frame image, encoding meta information including vertex connectivity information about the vertices and connections of the base mesh, and encoding the geometry image.

For example, an information processing device (e.g., a decoding device) may include a meta information decoding unit that decodes encoded data of meta information including vertex connectivity information, which is information about the vertices and connections of a base mesh, a geometry image decoding unit that decodes encoded data of a geometry image, which is a frame image having a patch arranged thereon, a vertex number increasing unit that increases the number of vertices of the base mesh using the vertex connectivity information, a patch reconstruction unit that reconstructs the patch using the geometry image and the base mesh with the increased number of vertices, and a vertex information reconstruction unit that generates reconstructed vertex information about the vertices of the base mesh with the increased number of vertices, by reconstructing the three-dimensional position of the vertices of the base mesh with the increased number of vertices using the reconstructed patch. The base mesh is 3D data that represents a three-dimensional structure of an object by vertices and connections and has fewer vertices than the target mesh, and the patch is a divided part of the target mesh that represents the base mesh as a projection plane.

For example, an information processing method (e.g., a decoding method) may include decoding encoded data of meta information including vertex connectivity information, which is information about vertices and connections of a base mesh, decoding encoded data of a geometry image, which is a frame image having a patch arranged thereon, increasing the number of vertices of the base mesh using the vertex connectivity information, reconstructing the patch using the geometry image and the base mesh with the increased number of vertices, and generating reconstructed vertex information about the vertices of the base mesh with the increased number of vertices, by reconstructing the three-dimensional position of the vertices of the base mesh with the increased number of vertices using the reconstructed patch. The base mesh is 3D data that represents a three-dimensional structure of the object by vertices and connections and has fewer vertices than the target mesh, and the patch is a divided part of the target mesh that represents the base mesh as a projection plane.

Here, the target mesh refers to a mesh to be encoded. The target mesh may be the original mesh input to the encoder or the original mesh with vertices reduced to some extent.

As described above, the base mesh is a mesh (3D data) which has fewer vertices than the target mesh and represents the three-dimensional structure of the object by vertices and connections. Each polygon of the base mesh is used as a projection plane. For example in VPCC, vertex connectivity information corresponding to a target mesh is encoded, but in the present disclosure, such a base mesh is generated at the encoder and the vertex connectivity information corresponding to the base mesh is encoded. However, the geometry patches and texture are encoded as higher resolution information than the base mesh. Then, at the decoder, the mesh is reconstructed using the vertex connectivity information corresponding to the base mesh and the geometry patches and texture that have higher resolution than the base mesh.

Therefore, the increase in the data amount of vertex connectivity information can be suppressed, and hence the increase in the code amount thereof can be suppressed. In addition, the mesh can be reconstructed with a higher resolution (a larger number of vertices) than the base mesh. In other words, by applying the present disclosure, the reduction in the encoding efficiency can be suppressed while suppressing the degradation of the subjective image quality.

### <Base Mesh>

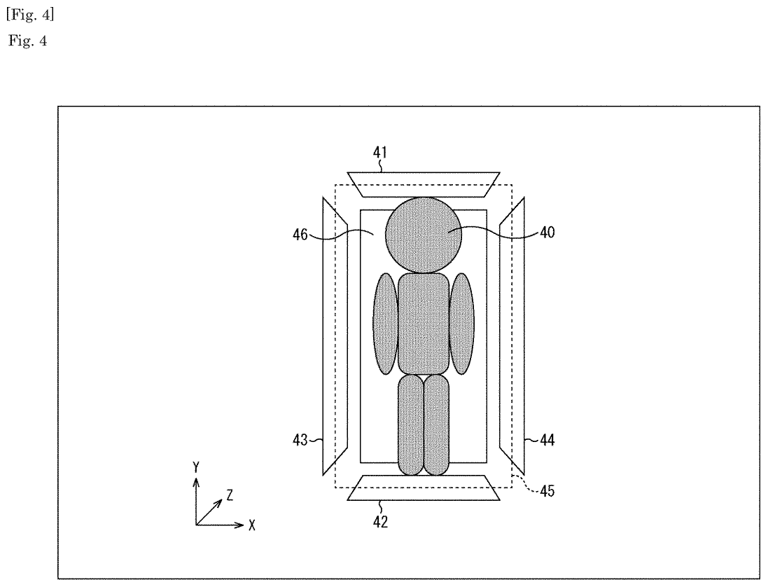

The base mesh will be described. In the case of the method described in NPL 2, the 3D coordinates of the vertices of a mesh are projected as a depth value onto a plane perpendicular to any of the 3D coordinate axes (X, Y, Z) (6 planes). For example, as shown in FIG. 4, when encoding a target mesh 40, each vertex of the target mesh 40 is projected onto one of the projection planes 41 to 46. The projection planes 41 and 42 are planes perpendicular to the Y-axis (ZX plane). The projection planes 43 and 44 are planes perpendicular to the X-axis (YZ-plane). The projection planes 45 and 46 are planes perpendicular to the Z axis (XY plane). In practice, each vertex of the target mesh 40 is divided into patches and is projected on a patch-by-patch basis onto the projection plane independently of each other. In other words, a projection plane exists for each patch. Here, in the following description, all patches (all vertices of the target mesh 40) are projected onto one of the projection planes 41 to 46 for the sake of convenience.

The 3D coordinates of a vertex are expressed as a pixel position and a pixel value in each of the projection planes. The pixel position indicates the position of the vertex in a direction parallel to its projection plane (e.g., X and Z coordinates for the projection plane 41). The pixel value indicates the depth value of the vertex from its projection plane (e.g., the distance between the projection plane 41 and the vertex (e.g., the Y coordinate of the vertex with respect to the projection plane 41) for the projection plane 41).

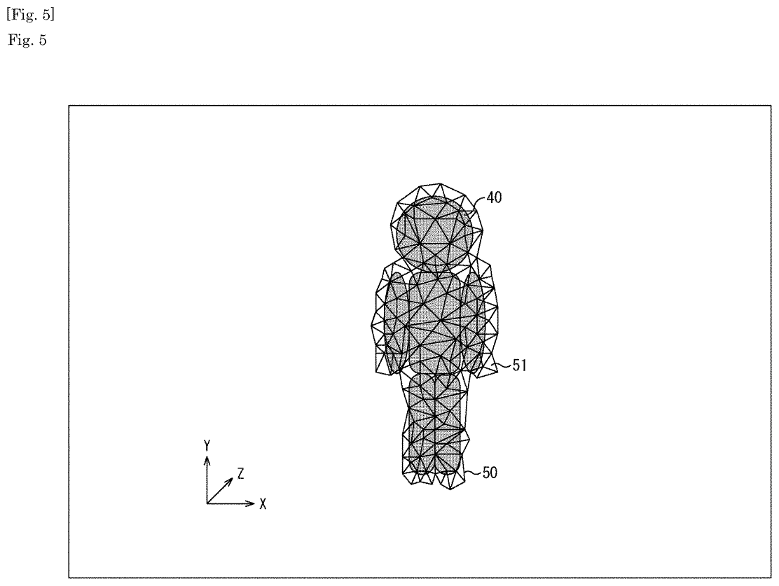

In contrast, in the present disclosure, as shown in FIG. 5, each polygon of the base mesh is used as a projection plane for the target mesh. The base mesh 50 shown in FIG. 5 has a lower resolution (fewer vertices and connections) than the target mesh 40, and each of polygons 51 formed by the vertices and connections is used as a projection plane. In FIG. 5, only one polygon is designated by a reference number, but the polygon 51 represents all the polygons that form the base mesh 50.

In the present disclosure, the vertex connectivity information corresponding to the base mesh 50 (i.e., regarding the vertices and connections of the base mesh) is encoded. Therefore, the number of vertices and connections indicated by the vertex connectivity information to be encoded is smaller than that of the vertex connectivity information corresponding to the target mesh, thus reducing the code amount of the vertex connectivity information. Accordingly, the reduction in the mesh encoding efficiency can be suppressed.

The polygon 51 and an adjacent polygon 51 are connected with each other (sharing a boundary). Therefore, it is easy to divide the target mesh into patches with these polygons 51 as units. In other words, the base mesh 50 can be divided so that a single or multiple adjacent polygons 51 form one patch, and the patch image can be made by projecting a group of vertices of the target mesh onto the polygons 51 in the patch.

In this way, the decoder can easily associate each patch image with the vertex connectivity information, if the vertices and connections in the vertex connectivity information are not divided into patches. In other words, the decoder can easily divide the vertex connectivity information into patches similarly to the patch images, provided that the method of dividing the base meshes 50 is known. Stated differently the encoder can encode the vertex connectivity information without dividing the vertices and connections in the vertex connectivity information into patches.

### <Base Mesh on Frame Basis (#1-1)>

As shown in the second row from the top of the table in FIG. 3, the base mesh may be transmitted on a frame-by-frame basis (#1-1). For example, assume that the target mesh is dynamic in the time direction (also simply referred to as dynamic) as in the case of a 2D moving image. The dynamic mesh is formed as data at prescribed time intervals, like frame images in a moving image. The data of such a dynamic mesh at prescribed time intervals is also referred to as frames.

Abase mesh may be generated and encoded for each frame of such a dynamic target mesh. For example, in an information processing device (e.g., an encoding device), a base mesh generation unit may generate a base mesh for each frame of the target mesh. In this way, an arbitrary base mesh can be applied to each frame of the dynamic target mesh.

### <Base Mesh Common Among Multiple Frames (#1-2)>

As shown in the third row from the top of the table in FIG. 3, a (common) base mesh corresponding to multiple frames may be transmitted (#1-2). For example, the base mesh may be generated in some frames, and other frames may be referenced in the remaining frames (i.e., the base mesh generated in the other frames may be applied).

For example, in an information processing device (e.g., an encoding device), the base mesh generation unit may generate a common base mesh for multiple frames of a target mesh. In this case, the vertex connectivity information about frames that reference the base mesh in other frames may include identification information of another frame (i.e., the frame to which the reference is made). In that case, the identifying information may be any kind of information. For example, the identifying information may be the serial number of the frame in the sequence, or the number of frames between the frame that is the reference source (i.e., the current frame) and the frame that is the reference destination.

For example, in an information processing device (e.g., a decoding device), the vertex connectivity information may include identification information about another frame, and the meta information decoding unit may refer to the base mesh vertex information about the vertices of the base mesh and the base mesh connectivity information about the connections of the base mesh corresponding to the other frame indicated by that identification information and obtain these kinds of information as the base mesh vertex information and the base mesh connectivity information corresponding to the current frame. More specifically the meta information decoding unit applies the base mesh (the vertices and the connections) applied to the other frame corresponding to the identification information included in the vertex connectivity information of the current frame to the current frame.

In this case, the identification information may be any kind of information. For example, the identification information may be the serial number of the frame in the sequence, or the number of frames between the frame that is the reference source (i.e., the current frame) and the frame that is the reference destination.

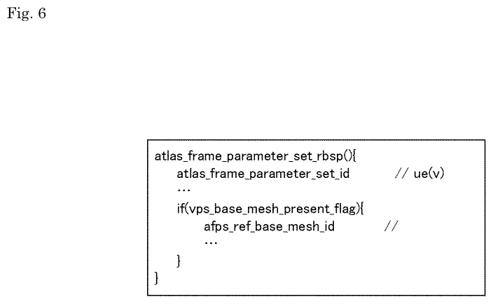

For example, as in the syntax shown in FIG. 6, in the frame parameter set (atlas_frame_parameter_set_rbsp0), which is a per-frame parameter set, the flag indicating whether a base mesh is present (vps_base_mesh_present_flag) may be set. If the flag is true (e.g., “1”), i.e., a base mesh generated in another frame (past frame) is referenced without generating a new base mesh, a parameter specifying the frame for referencing the base mesh (reference source frame) (afps_ref_base_mesh_id) may be set.

In this way in a frame that references another frame, the identification information of the referenced frame can be included in the vertex connectivity information instead of vertices and connections. More specifically the increase in the data amount of vertex connectivity information can be suppressed, and the reduction in the mesh encoding efficiency can be suppressed.

### <Base Mesh Generated on the Basis of Target Mesh (#1-3)>

As shown in the fourth row from the top of the table in FIG. 3, a base mesh generated on the basis of the target mesh may be transmitted (#1-3).

For example, in an information processing device (e.g., an encoding device), a base mesh generation unit may generate a base mesh by decimation of a target mesh.

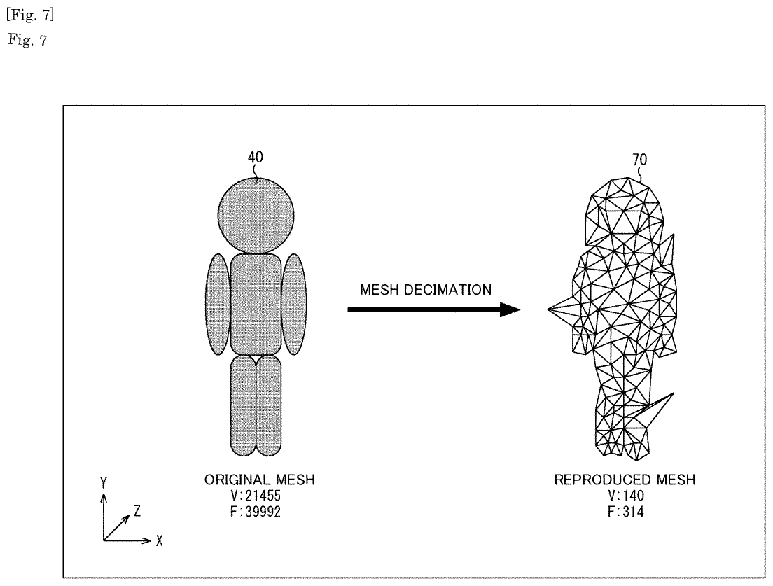

Decimation is the processing of reducing (thinning out) the vertices of the mesh and connections therebetween. For example, as shown in FIG. 7, a reproduced mesh 70 is obtained by decimating the target mesh 40 (the original mesh). In this example, the number of vertices (V) is reduced from 21455 to 140 and the number of connections (F) is reduced from 39992 to 314 due to decimation. By decimating the target mesh in this way, its vertices and connections therebetween may be reduced in generating a base mesh.

The base mesh generation unit may also generate a base mesh by deforming (modifying) its decimated target mesh.

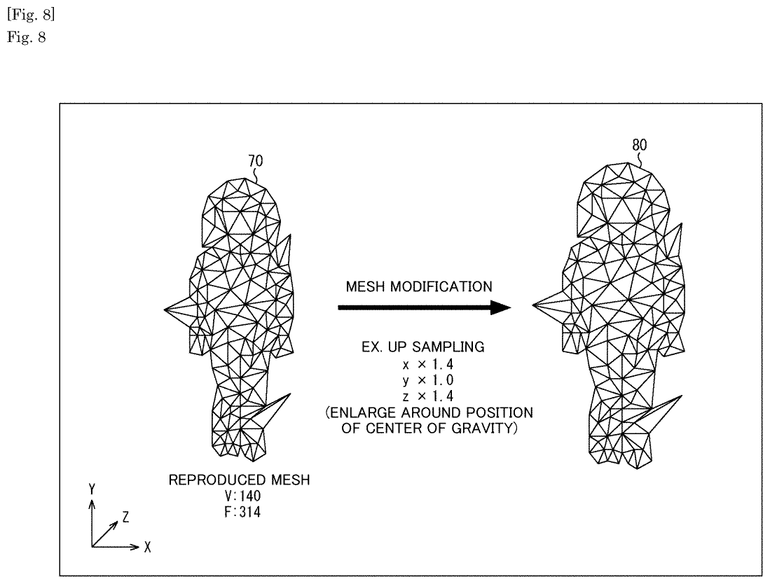

The processing content of the deformation (modification) of the mesh is arbitrary. For example, the modification may include the processing of enlarging or reducing the entire mesh (the boundary box that encompasses the mesh) in each of the directions of the 3D coordinates axes (i.e., deforming the entire mesh). In the example in FIG. 8, the reproduced mesh 70 is modified, so that a mesh 80 that is multiplied by 1.4 each in the x-axis and z-axis directions is produced.

The modification may also include the processing of moving vertices (i.e., local deformation of the mesh). For example, it is possible that the vertices may be moved significantly due to decimation or the like. If this happens, the shape of the base mesh may change significantly from the original mesh, which may make it difficult to use the polygons as projection planes. Therefore, it may be possible to correct the position of such vertices in this way so that these vertices are closer to their original positions (positions in the original mesh) by modification.

For example, vertices for which the distance between corresponding vertices between the target mesh and the base mesh generated on the basis of the target mesh is greater than a prescribed threshold may be identified as vertices to be subjected to position correction. The positions of the identified vertices in the base mesh may be corrected so that the distance is less than or equal to the threshold value.

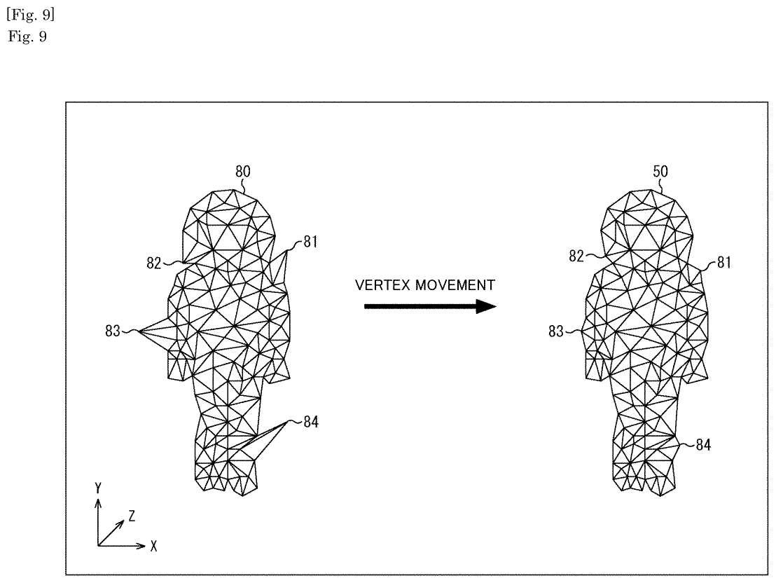

For example as shown in FIG. 9, assume that in a mesh 80, vertices 81, 82, 83, and 84 are significantly shifted from their positions in the original mesh for example by decimation. In the example in FIG. 9, the mesh 80 is further modified to correct the vertices 81 to 84, so that a base mesh 50 is generated. In this way the increase in the difference in shape between the base mesh 50 and the target mesh 40 can be suppressed.

In other words, the modification can expand or contract the mesh in each axis direction (global deformation). The modification can also move the vertices of the mesh (local deformation). The modification can also achieve both.

In other words, the base mesh can be generated by decimating the target mesh (or original mesh), or by further modifying (through global deformation or local deformation, or both) the decimated mesh based on the target mesh.

When a base mesh is generated on the basis of a target mesh as described above, for example, the vertex connectivity information may include vertex information about the vertices of the generated base mesh (also referred to as base mesh vertex information) and connectivity information about the connections of the base mesh (also referred to as base mesh connectivity information).

### <Base Mesh Generated on the Basis of Base Mesh Primitive (#1-4)>

As shown in the fifth row from the top of the table in FIG. 3, a base mesh generated on the basis of a base mesh primitive may also be transmitted (#1-4). The base mesh primitive is sample data on a mesh prepared in advance and is information known to the encoder and decoder. The base mesh primitive includes information about at least the vertices and connections of the mesh. The base mesh primitive is sometimes simply referred to as a prepared mesh model.

For example, in an information processing device (e.g., an encoding device), a base mesh generation unit may generate a base mesh using a prepared base mesh primitive.

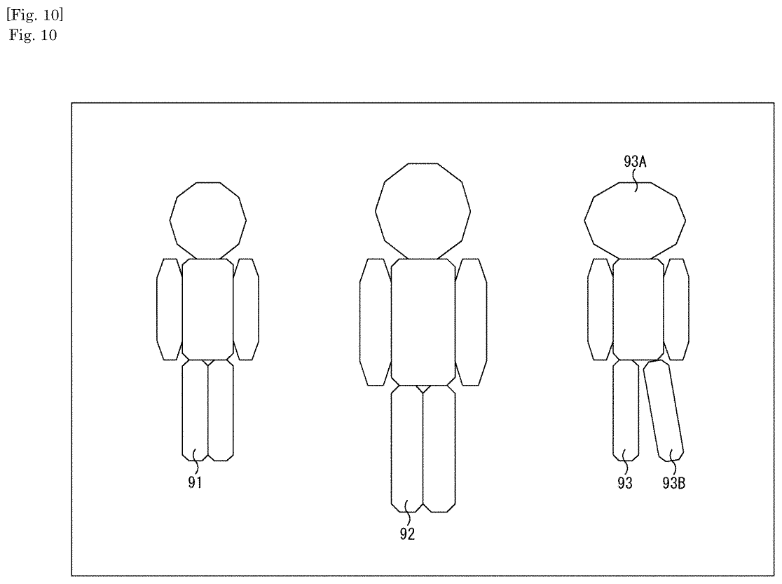

For example, if a target mesh is human-shaped, the base mesh may be generated using a human-shaped base mesh primitive 91 prepared in advance, as shown in FIG. 10.

For example, the base mesh generation unit may generate the base mesh by deforming its base mesh primitive. The manner of deformation is arbitrary. For example, the base mesh generation unit may generate a base mesh by enlarging, reducing, rotating, or moving the entire base mesh primitive. The base mesh generation unit may also generate the base mesh by moving, increasing, or reducing the vertices of the base mesh primitive.

When deforming the entire base mesh primitive, for example, the boundary box that encompasses the base mesh primitive may be enlarged, reduced, rotated, or moved. For example, the boundary box of the base mesh primitive and the boundary box of the target mesh may be determined, respectively and the boundary box of the base mesh primitive may be enlarged, reduced, rotated, or moved so that both boundary boxes match or approximate.

When moving the vertices of the base mesh primitive, vertices for which the distance between corresponding vertices between the target mesh and the base mesh primitive is greater than a prescribed threshold may be identified as vertices to be subjected to position correction. The position of the identified vertex in the base mesh primitive may be corrected so that the distance is equal to or less than the threshold value. Vertices may be added or reduced as appropriate, for example according to the correspondence of vertices between the target mesh and the base mesh primitive, the distance between vertices of the deformed base mesh primitive.

For example, as shown in FIG. 10, a base mesh may be generated by deforming the base mesh primitive 91. For example, a base mesh 92 may be generated by enlarging the entire base mesh primitive 91. Abase mesh 93 may also be generated by moving, increasing, or reducing the vertices of the base mesh primitive 91. As a result of these kinds of processing, the base mesh 93 has its head part 93A and left leg part 93B deformed.

The shape of the base mesh primitive is arbitrary and may be other than the human shape in the example in FIG. 10. In addition, multiple candidates for the base mesh primitive may be prepared and an applicable base mesh primitive may be selected from the candidates.

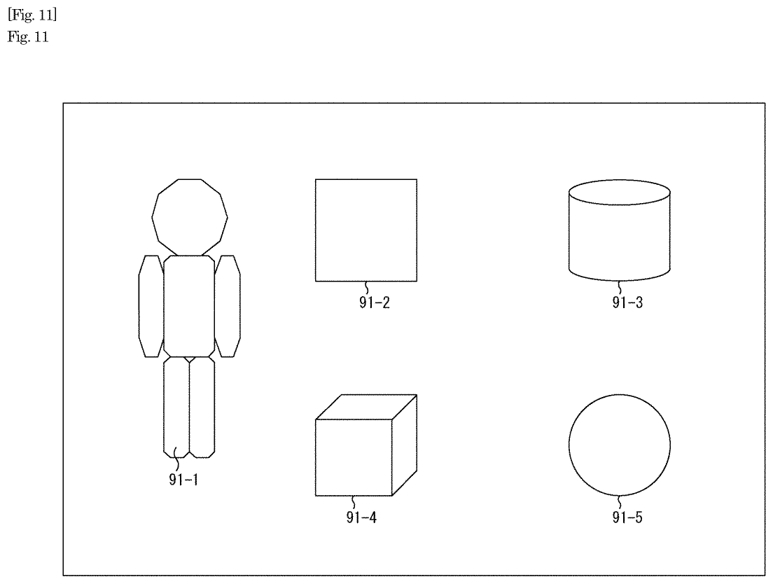

For example, as shown in FIG. 11, base mesh primitives 91-1 to 91-5 may be prepared as candidates. The base mesh primitive 91-1 is a human-shaped mesh. The base mesh primitive 91-2 is a square mesh. The base mesh primitive 91-3 is a cylindrical mesh. The base mesh primitive 91-4 is a cubic mesh. The base mesh primitive 91-5 is a spherical mesh. As a matter of course, the number and shapes of the base mesh primitive candidates are arbitrary and not limited to the examples shown in FIG. 11.

The encoder may, for example, select a candidate suitable for the shape of the target mesh among the candidates prepared in this way and use the selected candidate as the base mesh primitive. The encoder may then generate a base mesh by deforming the selected base mesh primitive.

Multiple candidates are prepared in this way so that the encoder can more easily generate a base mesh using a base mesh primitive that is more suitable for the shape of the target mesh. For example, by using a base mesh primitive that more closely approximates the shape of the target mesh, the encoder can reduce the amount of processing for deforming the base mesh primitive in generating the base mesh.

At the time, the encoder may transmit identification information of the selected candidate. For example, the vertex connectivity information may include identification information of the base mesh primitive applied to generate the base mesh.

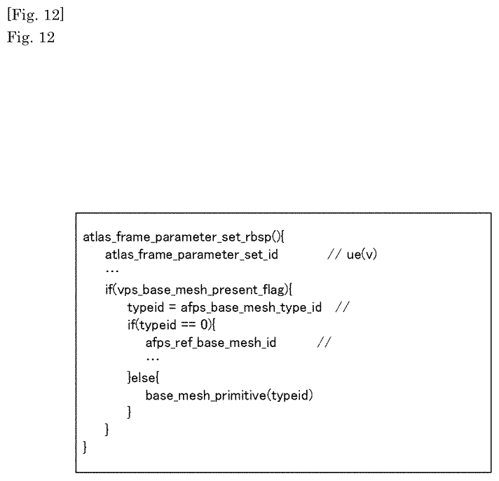

For example, as in the syntax shown in FIG. 12, in the frame parameter set (atlas_frame_parameter_set_rbsp0), the identification information (afps_base_mesh_type_id) of the base mesh primitive applied to generate the base mesh may be set as “typeid”. In other words, the base mesh primitive corresponding to the identification information indicated as “typeid” is applied to generate the base mesh. If typeid==0, the base mesh of another frame may be referenced.

In this way the encoder can reduce the amount of data in the vertex connectivity information compared to the case of generating the base mesh using the target mesh. Accordingly the encoder allows for the suppression of the reduction in the encoding efficiency.

The vertex connectivity information may further include parameters that are applied to the base mesh primitive. For example, the parameters may include those applied to the affine transformation of the base mesh primitive.

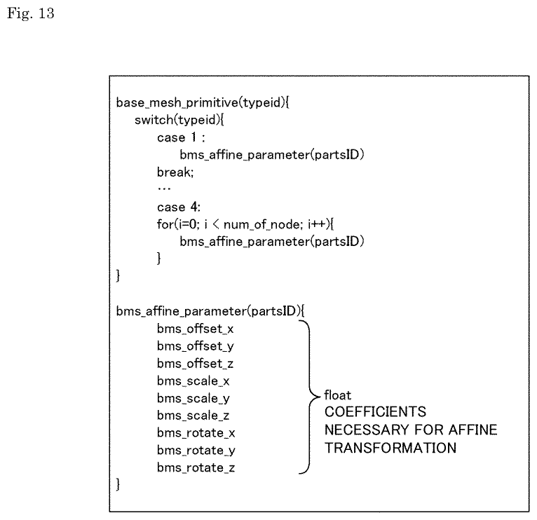

For example, the parameters applied to a base mesh primitive as “base_mesh_primitive(typeid)” may be stored in a frame parameter set (atlas_frame_parameter_set_rbsp0), as in the syntax shown in FIG. 12. An example of the syntax of base_mesh_primitive(typeid) is shown in FIG. 13. In FIG. 13, as for the parameter (base_mesh_primitive(typeid)), various parameters applied in the affine transformation of the base mesh primitive are set as “bms_affine_parameter(partsID)”. Parameters bms_offset_x, bms_offsety, and bms_offset_z indicates the offset in the X-axis direction, the offset in the Y-axis direction, and the offset in the Z-axis direction, respectively Parameters bms_scale_x, bms_scale_y, and bms_scale_z indicates the scale ratio in the X-axis direction, the scale ratio in the Y-axis direction, and the scale ratio in the Z-axis direction, respectively Parameters bms_rotate_x, bms_rotate_y, and bms_rotate_z indicates the amount of rotation in the X-axis direction, the amount of rotation in the Y-axis direction, and the amount of rotation in the Z-axis direction, respectively.

The base mesh primitive may include multiple parts, each of which can be deformed as described above (the entire part may be enlarged, reduced, rotated, or moved or vertices included in the part may be moved, added, or reduced). In other words, each part can be considered as a base mesh primitive. Stated differently a single base mesh may be generated using multiple base mesh primitives.

In the example in FIG. 13, when case 4 is selected as parameters (base_mesh_primitive(typeid)), the base mesh primitive includes multiple parts, and various parameters (bms_affine_parameter(partsID)) applied in the affine transformation are set for each part. When multiple parts are included, the num_of_node is predefined.

Since the base mesh is generated using the multiple parts (multiple base mesh primitives) in this way the amount of processing for deforming the base mesh primitives can be reduced.

Abase mesh may be generated in the decoder similarly to the encoder. For example, in an information processing device (e.g., decoder), the vertex connectivity information may include the identification information of a prepared base mesh primitive, and the meta information decoding unit may use the base mesh primitive corresponding to the identification information to generate base mesh vertex information about the vertices of the base mesh and base mesh connection information about the connections of the base mesh.

For example, the meta information decoding unit may generate base mesh vertex information and base mesh connectivity information by enlarging, reducing, rotating, or moving the entire base mesh primitive.

For example, the vertex connectivity information may further include parameters that are applied to the base mesh primitive, and the meta information decoding unit may apply those parameters to enlarge, reduce, rotate, or move the entire base mesh primitive.

The parameters may also include parameters applied in affine transformation of the base mesh primitive.

The meta information decoding unit may also generate base mesh vertex information and base mesh connectivity information by moving, increasing, or reducing the vertices of the base mesh primitive.

In this way the decoder can generate the base mesh in a similar manner to the encoder. Therefore, the decoder can achieve the same advantageous effect as the encoder. The decoder can also reconstruct patches similar to those generated by the encoder. Therefore, the decoder can reconstruct the mesh more accurately and can suppress the reduction in the subjective image quality of the reconstructed mesh.

### <Multiple Base Meshes in One Frame (#1-5)>

As shown in the sixth row from the top of the table in FIG. 3, multiple base meshes may be transmitted in a single frame. For example, there may be multiple target meshes in one frame (#1-5). In other words, there may be multiple objects in one frame.

For example, in an information processing device (e.g., an encoding device), the base mesh generation unit may generate multiple base meshes for one frame of the target mesh. Stated differently the vertex connectivity information for one frame of the target mesh may include information about the multiple base meshes. In other words, the vertex connectivity information about the multiple base meshes may be encoded for one frame of the target mesh.

In an information processing device (e.g., a decoding device), the vertex connectivity information may include information about the vertices and connections for each of the multiple base meshes corresponding to one frame of the target mesh.

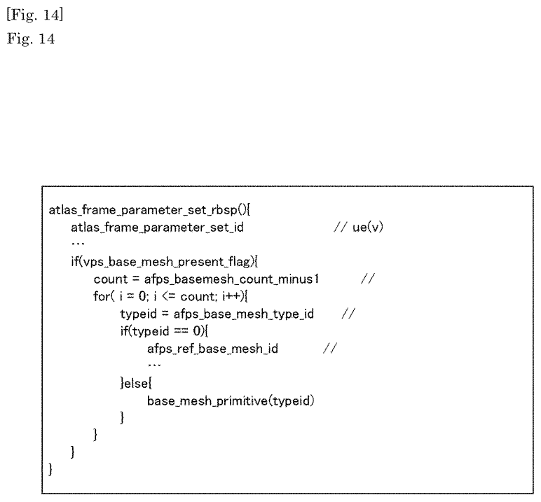

In that case, for example, parameters (afps_basemesh_count_minus1) indicating the number of base meshes to be generated may be set, as in the syntax shown in FIG. 14, and stored in the frame parameter set (atlas_frame_parameter_set_rbsp0).

In the frame parameter set, the identification information (afps_base_mesh_type_id) of the base mesh primitive applied to generate the base mesh may be set as “typeid” for each base mesh. In other words, the base mesh primitive corresponding to the identification information indicated as “typeid” for each base mesh is applied to generate the base mesh. The parameters (base_mesh_primitive(typeid)) applied to the base mesh primitive may be set for each base mesh.

### <Generation of Geometry Image Using Base Mesh (#1-6)>

As shown in the seventh row from the top of the table in FIG. 3, a base mesh may also be used to generate the geometry image (#1-6).

For example, an information processing device (e.g., an encoding device) may further include a vertex number increasing unit that increases the number of vertices of the base mesh, and the patch generation unit may generate multiple patches by projecting the divided parts of the target mesh onto the base mesh with the increased number of vertices.

In this way, the patches with a higher resolution (a larger number of vertices) than the base mesh can be generated. Therefore, the reduction in subjective image quality of the reconstructed mesh can be suppressed.

### <Tessellation of Base Mesh (#1-6-1)>

In such a case, for example, as shown in the eighth row from the top of the table in FIG. 3, the number of vertices in the base mesh may be increased by tessellating the base mesh (#1-6-1).

For example, in an information processing device (e.g., an encoding device), the number of vertices may be increased by the vertex number increasing unit by dividing the polygons of the base mesh.

In an information processing device (e.g., a decoding device), the vertex number increasing unit may increase the number of vertices by dividing the polygon of the base mesh.

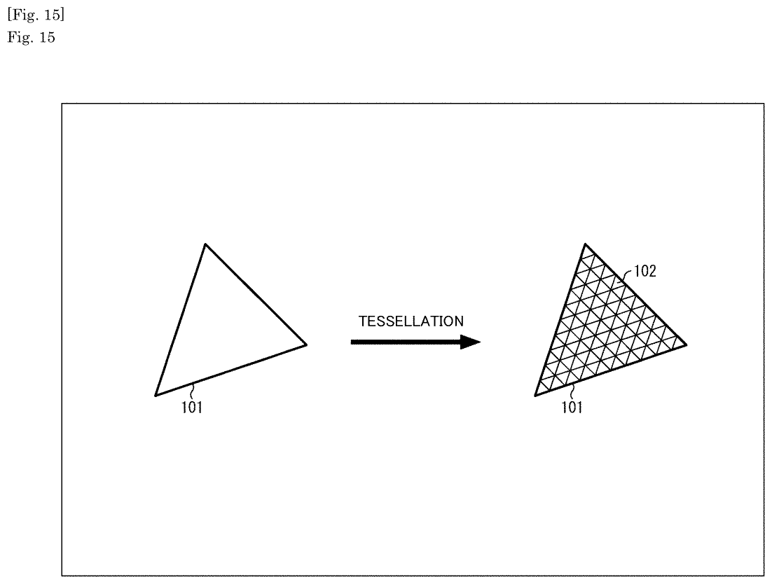

Tessellation is the processing of dividing a polygon and generating a plurality of polygons, for example, as shown in FIG. 15. In the example in FIG. 15, one polygon 101 is tessellated and a number of polygons 102 are formed within the polygon 101. In other words, tessellation creates new vertices and connections. Stated differently, the tessellation results in a highly detailed mesh.

Therefore, the encoder and decoder can more easily refine the base mesh.

An information processing device (e.g., an encoding device) may further include a tessellation parameter generation unit that generates tessellation parameters that are applied in the division of polygons. The tessellation parameters may include a tessellation level for the boundary edges of the patch and a tessellation level for the inside of the patch.

In an information processing device (e.g., a decoding device), the vertex number increasing unit may divide the polygon using the tessellation parameters. The tessellation parameters may include a tessellation level for the boundary edges of the patch and a tessellation level for the inside of the patch.

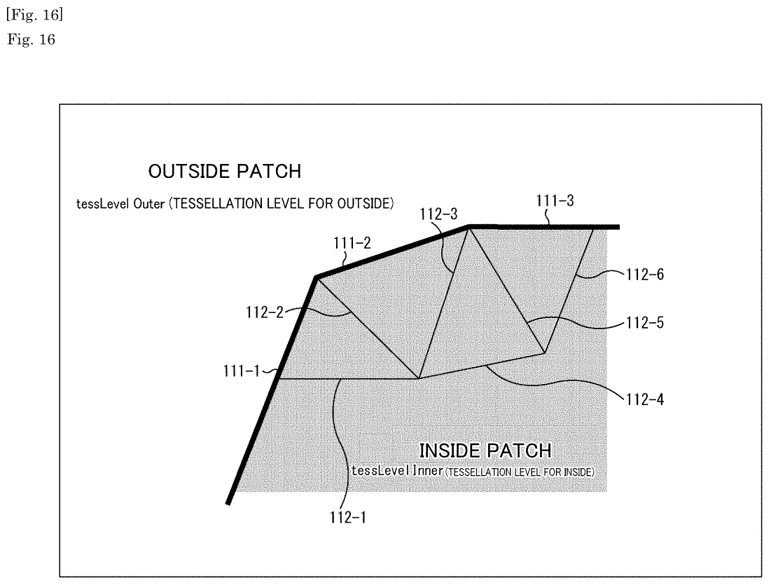

For example, in FIG. 16, the thick line represents the patch boundary (the edge of the patch), the part shown in gray beyond the thick line represents the inside of the patch, and the opposite side represents the outside of the patch. In other words, edges 111-1, 111-2, and 111-3 are patch boundaries. Edges 112-1, 112-2, 112-3, 112-5, and 112-6 are connections inside the patch.

In such a case, the tessellation level for the boundary edges of the patch (tessLevelOuter) and the tessellation level for the inside of the patch (tessLevelInner) may be set as the tessellation parameters.

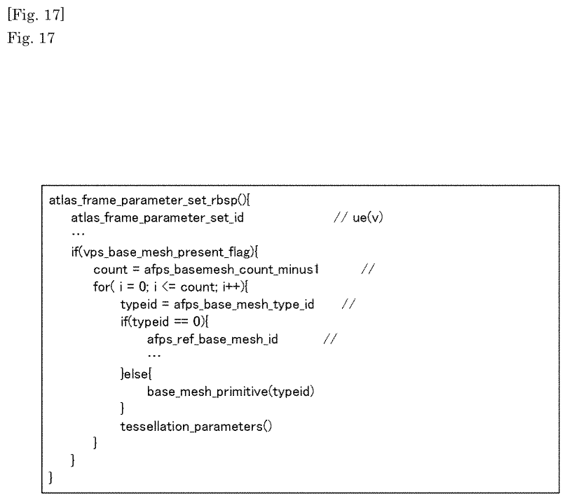

FIG. 17 shows an example of the syntax of the frame parameter set in such a case. As shown in FIG. 17, tessellation parameters (tessellation_parameters( )) are set and stored in the frame parameter set in this case. For example, as the tessellation parameter, the tessellation level for the boundary edges of the patch (tessLevelOuter) and the tessellation level for the inside of the patch (tessLevelInner) may be set, as described above. In this way, by transmitting the tessellation parameters, the decoder can perform tessellation using the same tessellation parameters as those for the encoder. Therefore, the decoder can increase the number of vertices in the same manner as the encoder.

The tessellation parameters may be set for each polygon of the base mesh. Alternatively, the initial values for the tessellation parameters may be set for all polygons, and the updated value may be applied only to the polygon whose value is to be updated. In such a case, the initial value, the identification information of the polygon whose value is to be updated, and the updated value may be transmitted to the decoder as the tessellation parameters.

In other words, the tessellation parameters may include the initial value, the identification information of the polygon whose value is to be updated, and the updated value.

The tessellation parameters may include an initial value, the identification information of a polygon whose value is to be updated, and an updated value, and in an information processing device (a decoding device), the vertex number increasing unit may apply the initial value to the tessellation parameters for all polygons in the base mesh, and update the tessellation parameters for the polygon specified by the identification information using the updated value.

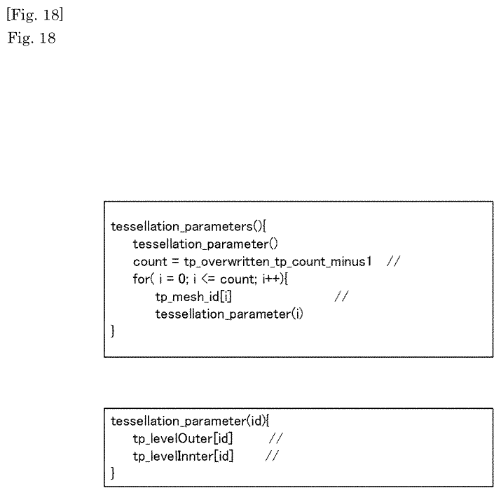

For example, as shown in the syntax on the top side of FIG. 18, the initial value for the tessellation parameter (tessellation_parameter0) can be set. For polygons (tp_mesh_id[i]) whose tessellation parameters are to be updated, their values can be updated to the new values (tessellation_parameter(i)). As the tessellation parameters, the tessellation level for the patch boundary edges (tp_levelOuter[id]) and the tessellation level for the inside of the patch (tp_levelInnter[id]) can be set as in the syntax shown in the lower part of FIG. 18.

### <Patch on Base Mesh Polygon Basis (#1-6-2)>

As shown in the ninth row from the top of the table in FIG. 3, the base mesh may also be used to generate a geometry image (#1-6-2).

For example, in an information processing device (e.g., encoding unit), the patch generation unit may divide the target mesh into units of small regions that are projected onto the same polygon of the base mesh. The patch is generated in this way so that the patch can be generated more easily. This also allows patch images to be easily associated with vertex connectivity information.

In an information processing device (e.g., encoding unit), the patch generation unit may calculate the difference in position between each of the vertices of the base mesh with an increased number of vertices and the target mesh. For example, the patch generation unit may calculate the difference for the vertical direction of the surface of the base mesh. The patch generation unit may also calculate the difference along any of the three-dimensional coordinate axes.

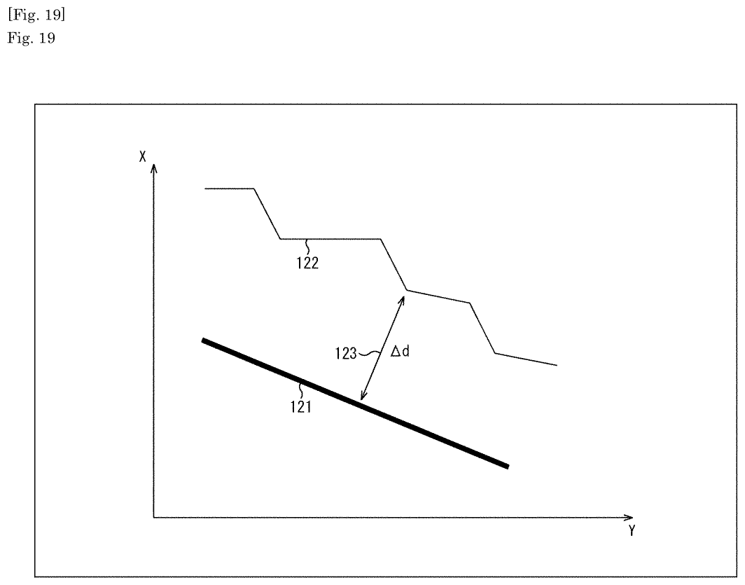

For example, in FIG. 19, the thick line 121 indicates the surface of the base mesh (with the increased number of vertices), and the curve 122 indicates the surface of the target mesh. The patch of the target mesh is projected onto the surface of the base mesh, so that the patch image is formed on the surface of the base mesh indicated by thick line 121. The pixel values represent the difference between the position of the surface of the target mesh and the position of the surface of the base mesh. For example, by obtaining this difference for each vertex of the base mesh with the increased number of vertices (i.e., the difference in position between each vertex of the base mesh with the increased number of vertices and the target mesh) and using the difference as the pixel value of the patch image, a higher resolution (a larger number of vertices) patch image than the base mesh is obtained. The patch image is transmitted as a geometry image, and by using the geometry image (patch image) in the decoder, a mesh with a higher resolution (more vertices and connections) than the base mesh can be reconstructed. Therefore, if the base mesh has a lower resolution (fewer vertices and connections) than the target mesh, the reduction in subjective image quality can be suppressed. Therefore, the reduction in the encoding efficiency can be suppressed while suppressing the degradation of the subjective image quality.

The difference in position between each of the vertices of the base mesh with the increased number of vertices and the target mesh may be the vertical difference Δd (a depth value in the direction indicated by the bidirectional arrow 123) on the surface of the base mesh, as in the example in FIG. 19.

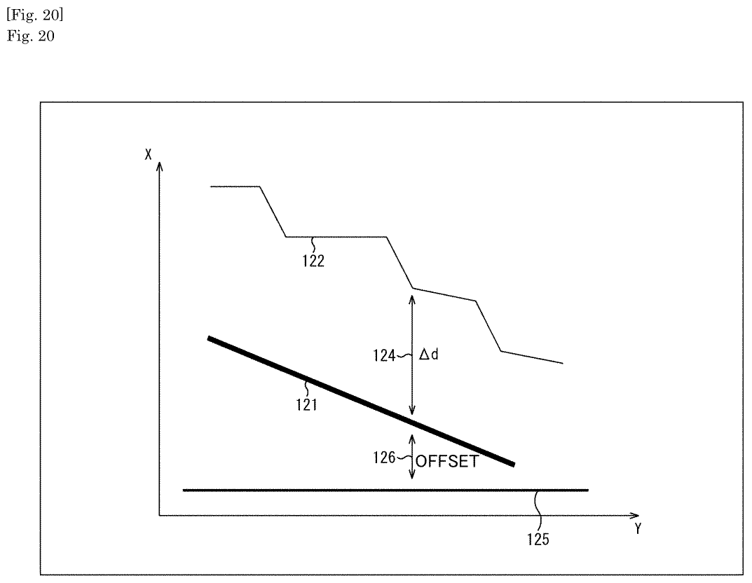

The difference in position between each of the vertices of the base mesh with the increased number of vertices and the target mesh may be the difference Δd (e.g., depth value in the direction indicated by bidirectional arrow 124) along any of the three-dimensional coordinate axes (i.e., any of the X, Y, and Z directions), as in the example in FIG. 20. Stated differently the difference in this case may be the vertical difference Δd (depth value) on a projection plane that is perpendicular to any of the three-dimensional coordinate axes (X, Y, Z) indicated by the straight line 125.

The decoder can also reconstruct a patch basically by the same method that the encoder uses to generate a patch.

For example, in an information processing device (e.g., decoding device), the patch reconstruction unit may reconstruct a patch by dividing a base mesh with an increased number of vertices for each small region and extracting a part corresponding to the small region from the geometry image. The small regions may be polygons of the base mesh. The patch reconstruction unit may reconstruct a patch by extracting pixel values corresponding to vertices in the small region from the geometry image. The polygon-based division into patches enables the decoder to easily reconstruct them. This also allows patch images to be easily associated with vertex connectivity information.

In an information processing device (e.g., a decoding unit), the vertex information reconstruction unit may generate reconstructed vertex information by arranging vertices at positions vertically away from the small region by the distance indicated by the pixel values. For example, in an information processing device (e.g., a decoding unit), the vertex information reconstruction unit may generate the reconstructed vertex information by arranging the vertices in positions away from the small region along any of the three-dimensional coordinate axes by the distance indicated by the pixel values. The vertex information reconstruction unit may also calculate the offset of the small region with respect to a plane perpendicular to any of the three-dimensional coordinate axes and use the offset to arrange the vertices.

In other words, the decoder can extract a patch image from the geometry image and interpret the pixel value of each vertex position in the patch image as the difference between the position of each vertex of the base mesh with an increased number of vertices and the target mesh, and thus identify the three-dimensional position of each vertex in each patch with respect to the projected plane. In other words, the patches are reconstructed. In this case, the pixel value of each vertex position in the patch image may be the vertical difference Δd of the surface of the base mesh (in the direction of extension of the bidirectional arrow 123), as in the example in FIG. 19 or may be the difference Δd along any of the three-dimensional coordinate axes, as in the example in FIG. 20. When the difference Δd is along any of the three-dimensional coordinate axes, the decoder may calculate the offset (the bidirectional arrow 126) of the surface of the base mesh (the thick line 121) with respect to the projection plane (straight line 125) perpendicular to any of the three-dimensional coordinate axes, as shown in FIG. 20. The decoder may then use the offset and Δd to determine the position of the surface of the base mesh.

This offset can be derived, for example, using a plane equation. For example, the equation of a plane that passes through the point P (x0, y0, z0) and has a normal vector (a, b, c) can be expressed as shown in the following equation (1).

$$a ( x - x 0 ) + b ( y - y 0 ) + c ( z - z 0 ) = 0 \qquad ( 1 )$$

### <Generation of Geometry Image (#1-6-3)>

As shown in the tenth row from the top of the table in FIG. 3, a geometry image may be generated by arranging patches (patch images) on the frame (#1-6-3).

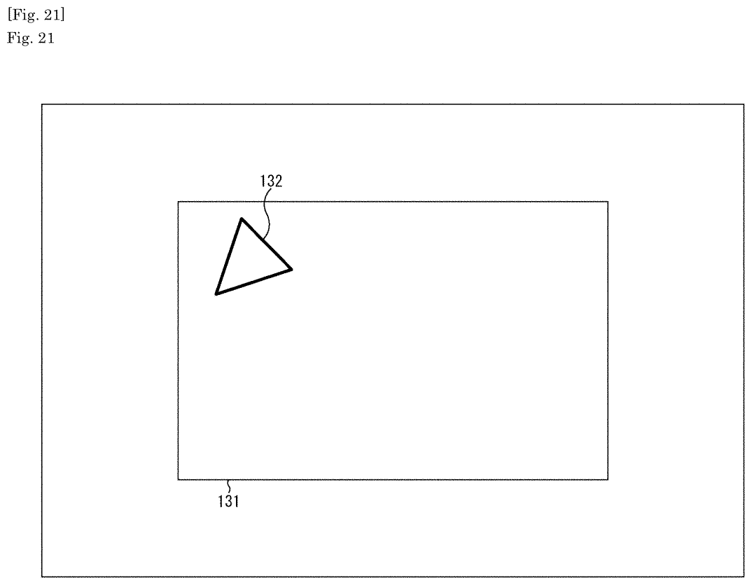

For example, as shown in FIG. 21, a patch image 132 may be arranged at any position in a geometry frame (two-dimensional image) 131. Although the patch image 132 is formed by a single polygon (triangle), the shape of the patch image 132 is arbitrary, and the patch image 132 may be formed by multiple polygons. The pixel value of the patch image 132 is composed of the difference in position (depth value) between the vertices of the base mesh with an increased number of vertices and a target mesh. Therefore, by arranging the patch image 132 in the geometry frame 131 as in the example in FIG. 21, the pixel value of the geometry image is composed of the difference (depth value) in position between each vertex of the base mesh with the increased number of vertices and the target mesh.

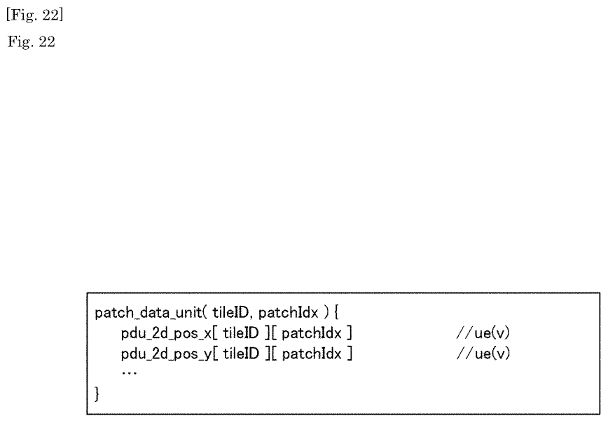

Since the arrangement of geometry is performed for each patch in this way, patch arrangement information indicating for each patch the position (two-dimensional coordinates) where the geometry is arranged may be transmitted from the encoding side to the decoding side. In other words, the patch arrangement information indicates the position (two-dimensional coordinates) where the reference position of each patch is arranged. For example, the patch arrangement information may be stored in the patch data unit as shown in the syntax in FIG. 22. In FIG. 22, pdu_2d_pos_x[tileID][patchIdx] indicates the x coordinate of the reference position of the patch in the geometry image. As shown, pdu_2d_pos_y[tileID][patchIdx] indicates the y coordinate of the reference position of the patch in the geometry image. The patch arrangement information may include such a two-dimensional coordinates of the reference position of each patch.

The encoder generates the patch arrangement information during geometry image generation (when arranging the patch) and encodes the patch arrangement information.

The decoder decodes the encoded data to obtain the patch arrangement information. Then, the decoder identifies the position where those patches are arranged in the geometry image on the basis of the patch arrangement information after generating the patches in the same manner as the encoder. The decoder then extracts pixel values from the identified positions to obtain the patch image. Therefore, the decoder can easily obtain the patch image.

### <Encoding Vertex Connectivity Information and Geometry Image (#1-7)>

As shown in the 11th row from the top of the table in FIG. 3, the base mesh (vertex connectivity information) and the geometry image may also be encoded (#1-7). The method for encoding the base mesh (vertex connectivity information) is arbitrary. For example, the method may be MPEG4 AFX or Draco. Alternatively the method may be intra encoding (i.e., encoding independently for each frame). The method may also be inter encoding (i.e., encoding using correlation between frames). For example, the encoder may derive the difference in vertex connectivity information between frames and encode the difference.

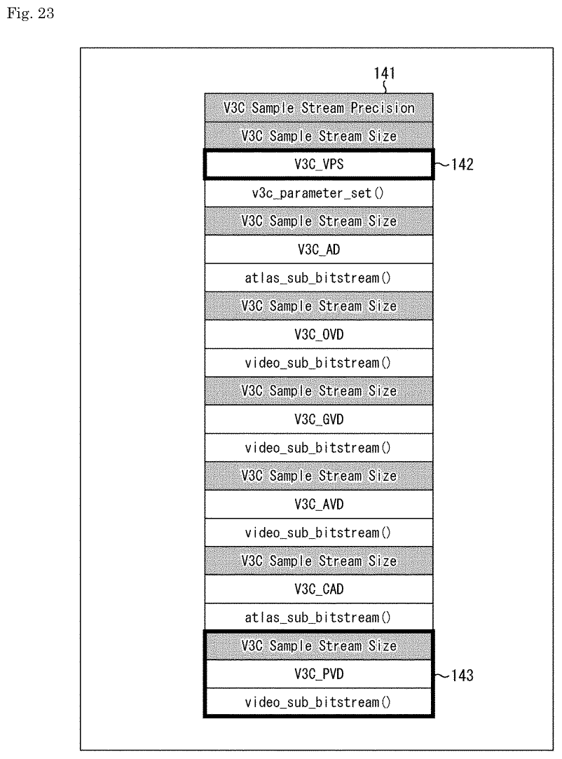

FIG. 23 illustrates an exemplary configuration of a bit stream when the present disclosure is applied. The bit stream 141 shown in FIG. 23 is obtained by applying the present disclosure to encode a target mesh. The bit stream of the geometry image is stored in V3C_VPS, which is surrounded by a square frame 142. The bit stream of the base mesh (vertex connectivity information) is stored in V3C_Sample_Size, V3C_BMD, and base_mesh_sub_bitstream( ) enclosed by the square frame 143.

Information indicating the method for encoding the base mesh (identification information of the codec applied to encode the base mesh) may be transmitted from the encoding side to the decoding side. For example, information indicating the method for encoding the base mesh may be stored in the bit stream 141.

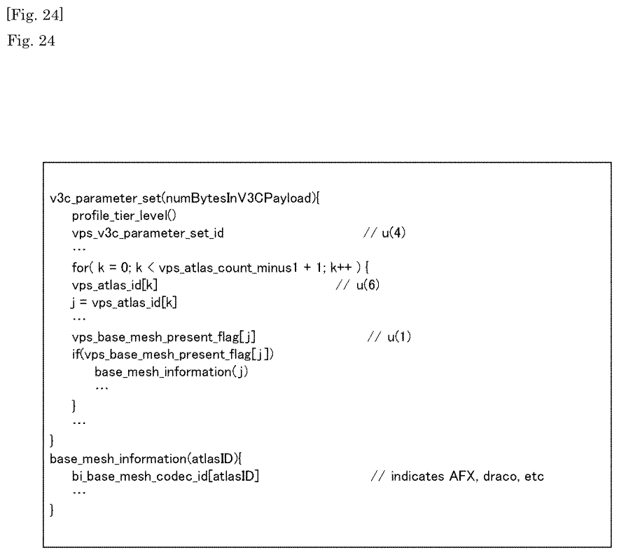

In this case, an example of the syntax of v3c_parameter_set is shown in FIG. 24. In this example, the identification information (bi_base_mesh_codec_id[atlasID]) of the codec applied to encode the base mesh is stored in the v3c_parameter_set as base mesh information (base_mesh_information(atlasID)).

The base mesh encoding method can be switched for each arbitrary data unit, such as a frame and a tile. Therefore, the identification information (bi_base_mesh_codec_id[atlasID]) of the codec applied for encoding the base mesh shown in FIG. 24 may also be stored for each arbitrary data unit. The information is transmitted, so that the decoder can easily identify the encoding method applied by the encoder. Thus, the decoder can correctly decode vertex connectivity information and geometry images.

### <Switching Between Projection Planes (#1-8)>

As shown in the lowermost row of the table in FIG. 3, the projection plane may be switched (#1-8). In other words, for example, the disclosure may be applied in some parts of the sequence of the target mesh and not in the other parts of the sequence. In this way for example, during a sequence, the projection plane can be switched from the base mesh to a plane (six planes) perpendicular to any of the three-dimensional coordinate axes (X, Y, Z).

The plane to be set as the projection plane may be any plane and may be other than the example described above (base mesh, six planes). There may be three or more types of planes that are candidates for the projection planes. In other words, a plane to be applied as a projection plane may be selected from three or more candidate types. The timing for switching the projection plane is arbitrary. For example, the switching may be performed on the basis of a prescribed data unit. For example, the projection plane to be applied may be switched for each patch.

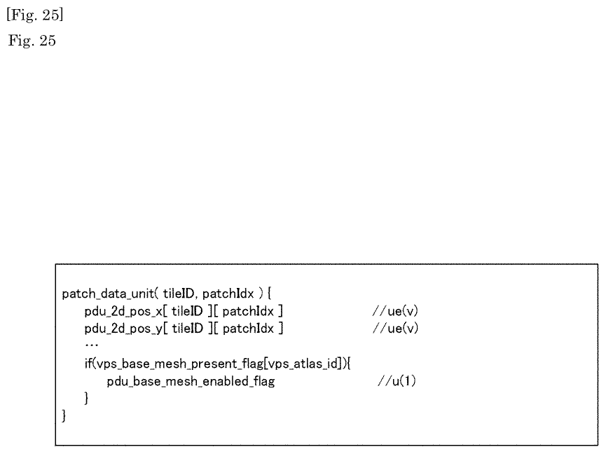

The information that indicates the applied projection plane may then be transmitted from the encoding side to the decoding side. FIG. 25 is a diagram of an example of a syntax of a patch data unit. For example, as shown in FIG. 25, pdu_base_mesh_enabled_flag may be stored in the patch data unit. The flag pdu_base_mesh_enabled_flag indicates whether to apply the present technology in other words, whether to apply a base mesh as a projection plane. As the value changes, the target projection plane to which the present technology is applied is switched. In this way the decoder can easily grasp the projection plane to which the technology has been applied by the encoder. Accordingly the decoder can reconstruct a mesh more easily and correctly.

### 4. First Embodiment

### <Encoding Device>

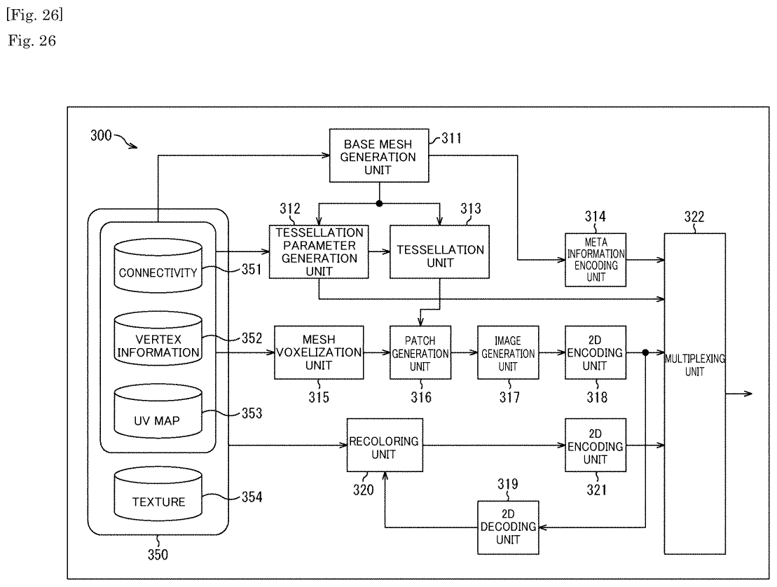

The present technology described in the foregoing can be applied to any device. For example, the present technology can be applied to an encoding device 300 as shown in FIG. 26. FIG. 26 is a block diagram of an exemplary configuration of an encoding device which is an information processing device according to one embodiment to which the present technology is applied. The encoding device 300 shown in FIG. 26 performs encoding according to an encoding method for two-dimensional images by extending VPCC and using 3D data with meshes as a video frame.

FIG. 26 shows principal components such as processing units and data flows, and FIG. 26 does not show all components. More specifically the encoding device 300 may include processing units that are not illustrated as blocks in FIG. 26 and processing and data flows that are not illustrated as arrows or the like in FIG. 26.

As shown in FIG. 26, the encoding device 300 has a base mesh generation unit 311, a tessellation parameter generation unit 312, a tessellation unit 313, a meta information encoding unit 314, a mesh voxelization unit 315, a patch generation unit 316, an image generation unit 317, a 2D encoding unit 318, a 2D decoding unit 319, a recoloring unit 320, a 2D encoding unit 321, and a multiplexing unit 322.

A target mesh 350 (which may be the original mesh) is supplied to the encoding device 300. The target mesh 350 includes, for example, connectivity 351, vertex information 352, a UV map 353, and a texture 354.

The connectivity 351 is information similar to the connectivity 32 (FIG. 2) and indicates each of the vertices that form a polygon (vertices connected to each other) for each polygon. The vertex information 352 is information similar to the vertex information 31 (FIG. 2) and indicates the coordinates of vertices that form a mesh. The UV map 353 is information similar to the UV map 34 (FIG. 2) and indicates the position of vertices on the texture image. The texture 354 is information similar to the texture image 33 (FIG. 2), and indicates the texture to be attached to the polygon. More specifically the texture 354 is information that includes a texture image.

The base mesh generation unit 311 performs processing related to the generation of a base mesh. For example, the base mesh generation unit 311 may obtain the connectivity 351, the vertex information 352, and the UV map 353 of the target mesh 350. The base mesh generation unit 311 may also generate the base mesh. The base mesh generation unit 311 may supply the generated base mesh (vertex connectivity information about the base mesh) to the tessellation parameter generation unit 312, the tessellation unit 313, and the meta information encoding unit 314.

The tessellation parameter generation unit 312 performs processing related to the generation of tessellation parameters. For example, the tessellation parameter generation unit 312 may obtain the connectivity 351, the vertex information 352, and the UV map 353 of the target mesh 350. The tessellation parameter generation unit 312 may also obtain the base mesh (vertex connectivity information about the base mesh) supplied by the base mesh generation unit 311. The tessellation parameter generation unit 312 may also generate tessellation parameters. The tessellation parameter generation unit 312 may supply the generated tessellation parameters to the tessellation unit 313 and the multiplexing unit 322.

The tessellation unit 313 performs processing related to tessellation, which increases the number of vertices in a mesh. In other words, the tessellation unit 313 can also be considered as a vertex number increasing unit. For example, the tessellation unit 313 may obtain a base mesh (vertex connectivity information) supplied by the base mesh generation unit 311 and increase the number of vertices in the mesh. The tessellation unit 313 may also obtain the tessellation parameters supplied by the tessellation parameter generation unit 312. The tessellation unit 313 may tessellate the base mesh using the tessellation parameters. The tessellation unit 313 may also supply the tessellated base mesh to the patch generation unit 316.

The meta information encoding unit 314 performs processing related to the encoding of meta information. For example, the meta information encoding unit 314 may obtain the vertex connectivity information about the base mesh supplied by the base mesh generation unit 311. The meta information encoding unit 314 may also encode the meta information including the vertex connectivity information about the base mesh and generate the encoded data of the information in the meta. The meta information encoding unit 314 may supply the generated encoded data of the meta information to the multiplexing unit 322.

The mesh voxelization unit 315 performs processing related to mesh voxelization. For example, the mesh voxelization unit 315 may obtain the connectivity 351, the vertex information 352, and the UV map 353 of the target mesh 350. The mesh voxelization unit 315 may also convert the coordinates of vertices included in the obtained vertex information 352 into a voxel grid. The mesh voxelization unit 315 may also supply the connectivity 351, the vertex information 352 about the voxel grid after the conversion, and the UV map 353 to the patch generation unit 316.

The patch generation unit 316 performs processing related to patch generation. For example, the patch generation unit 316 may obtain the connectivity 351, the vertex information 352 on the voxel grid after the conversion, and the UV map 353 supplied from the mesh voxelization unit 315. The patch generation unit 316 may also obtain the tessellated base mesh supplied from the tessellation unit 313. The patch generation unit 316 may also generate a patch (patch image) on the basis of the obtained information. The patch generation unit 316 may also supply the generated patch (patch image) to the image generation unit 317.

The image generation unit 317 performs processing related to the generation of a geometry image. For example, the image generation unit 317 may obtain a patch (patch image) supplied by the patch generation unit 316. The image generation unit 317 may also generate a geometry image for example by arranging the patch (patch image) on a two-dimensional plane. The image generation unit 317 may supply the generated geometry image as a geometry video frame to the 2D encoding unit 318.

The 2D encoding unit 318 performs processing related to the encoding of two-dimensional images. For example, the 2D encoding unit 318 may obtain a geometry image (geometry video frame) supplied by the image generation unit 317. The 2D encoding unit 318 may also encode the obtained geometry image using a two-dimensional image encoding method and generate encoded data of the geometry image. More specifically the 2D encoding unit 318 can be considered as a geometry image encoding unit. The 2D encoding unit 318 may supply the encoded data of the generated geometry image to the 2D decoding unit 319 and the multiplexing unit 322.

The 2D decoding unit 319 performs processing related to the decoding of the encoded data of two-dimensional images. For example, the 2D decoding unit 319 may obtain the encoded data of the geometry image supplied by the 2D encoding unit 318. The 2D decoding unit 319 may decode the encoded data by a decoding method corresponding to the encoding method applied by the 2D encoding unit 318 to generate (restore) the geometry image. The decoding unit 319 may also supply the generated (restored) geometry image to the recoloring unit 320.

The recoloring unit 320 performs processing related to the recoloring processing of the texture 354. For example, the recoloring unit 320 may obtain the target mesh 350 (the connectivity 351, the vertex information 352, the UV map 353, and the texture 354). The recoloring unit 320 may also obtain the restored geometry image supplied by the 2D decoding unit 319. The recoloring unit 320 may perform recoloring processing using the obtained information and correct the texture 354 so that the texture image corresponds to the restored geometry image. The recoloring unit 320 may also supply the corrected (recolored) texture 354 to the 2D encoding unit 321.

The 2D encoding unit 321 performs processing related to the encoding of two-dimensional images. For example, the 2D encoding unit 321 may obtain the corrected (recolored) texture 354 supplied from the recoloring unit 320. The 2D encoding unit 321 may also encode the texture 354 (texture image) by an encoding method for two-dimensional images and generate encoded data of the texture image. More specifically the 2D encoding unit 321 can be considered as a texture image encoding unit. The 2D encoding unit 321 supplies the generated encoded data of the texture image to the multiplexing unit 322.

The multiplexing unit 322 performs processing related to data multiplexing. The multiplexing unit 322 also obtains encoded data of meta information supplied from the meta information encoding unit 314. The multiplexing unit 322 may obtain tessellation parameters supplied from the tessellation parameter generation unit 312. The multiplexing unit 322 may also obtain encoded data of the geometry image supplied from the 2D encoding unit 318. The multiplexing unit 322 may also obtain the encoded data of the texture image supplied from the 2D encoding unit 321. The multiplexing unit 322 may also multiplexes the obtained data to generate a single bit stream. The multiplexing unit 322 may provide the generated bit stream to another device. More specifically, the multiplexing unit 322 can be considered as a providing unit.

The present technology described in connection with <3. Mesh compression using base mesh> may be applied to the encoding device 300 having the above-described configuration.

For example, in the encoding device 300, the base mesh generation unit 311 may generate a base mesh, which is 3D data representing a three-dimensional structure of an object by vertices and connections and has fewer vertices than a target mesh, the patch generation unit 316 may generate multiple patches by dividing the target mesh and projecting the divided parts onto the base mesh, and the image generation unit 317 may generate a geometry image by arranging the patches on a frame image, the meta information encoding unit 314 may encode meta information including vertex connectivity information about the vertices and connections of the base mesh, and the 2D encoding unit 318 may encode the geometry image.

The base mesh generation unit 311 may also generate a base mesh by the decimation of a target mesh.

The base mesh generation unit 311 may also generate a base mesh by deforming (modifying) the decimated target mesh.

When a base mesh is generated on the basis of a target mesh, for example, the vertex connectivity information may include vertex information about the vertices of the generated base mesh and connectivity information about the connections of the base mesh.

The base mesh generation unit 311 may generate a base mesh using a prepared base mesh primitive.

In this case, the vertex connectivity information may include the identification information of the base mesh primitive applied to generate the base mesh.

The vertex connectivity information may further include parameters that are applied to the base mesh primitive. For example, the parameters may include parameters applied in affine transformation of the base mesh primitive.

The base mesh generation unit 311 may also generate a base mesh by deforming the base mesh primitive. For example, the base mesh generation unit 311 may generate a base mesh by enlarging, reducing, rotating, or moving the entire base mesh primitive. The base mesh generation unit 311 may also generate a base mesh by moving, increasing, or reducing the vertices of the base mesh primitive.

The base mesh generation unit 311 may also generate a base mesh for each frame of a target mesh.

The base mesh generation unit 311 may also generate multiple base meshes for one frame of a target mesh.

The base mesh generation unit 311 may also generate a common base mesh for multiple frames of a target mesh. In this case, the vertex connectivity information about the frames that reference the base mesh in any of other frames may include the identification information of the other frames (i.e., the frames to be referenced).

For example, the identification information may be the serial number of the frame in the sequence or the number of frames between the frame that is the reference source (i.e., the current frame) and the frame that is the reference destination.

The tessellation unit 313 may increase the number of vertices of the base mesh, and the patch generation unit 316 may generate multiple patches by projecting the divided parts of the target mesh onto the base mesh with the increased number of vertices.

The tessellation unit 313 may also increase the number of vertices by dividing the polygons of the base mesh.

The tessellation parameter generation unit 312 may also generate tessellation parameters that are applied in the division of the polygons. The tessellation parameters may include a tessellation level for the boundary edges of a patch and a tessellation level for the interior of a patch.

The tessellation parameters may also include an initial value, identification information about the polygon whose value is to be updated, and the updated value.

The patch generation unit 316 may divide a target mesh into units of small regions projected onto identical polygons of the base mesh.

The patch generation unit 316 may calculate the difference in position between each of the vertices of the base mesh with an increased number of vertices and the target mesh. For example, the patch generation unit 316 may calculate the difference for the vertical direction of the surface of the base mesh. The patch generation unit 316 may also calculate the difference along any of the three-dimensional coordinate axes.

In this way the encoding device 300 can obtain the advantageous effects described in connection with <3. Mesh compression using base mesh>. More specifically the encoding device 300 can suppress the reduction in the encoding efficiency while suppressing the degradation of the subjective image quality.

These processing units (the base mesh generation unit 311 to the multiplexing unit 322) may have any configurations. For example, each of the processing units may be configured with a logical circuit that implements the aforementioned processing. Each of the processing units may have, for example, a central processing unit (CPU), a read only memory (ROM), and a random access memory (RAM) or the like, and the aforementioned processing may be implemented by executing a program using the CPU and the memories. It goes without saying that each processing unit may have both the aforementioned configurations, realize parts of the aforementioned processing according to a logic circuit, and realize the other part of the processing by executing a program. The processing units may have independent configurations, for example, some processing units may realize parts of the aforementioned processing according to a logic circuit, some other processing units may realize the aforementioned processing by executing a program, and some other processing units may realize the aforementioned processing according to both a logic circuit and execution of a program.

### <Flow of Encoding Processing>

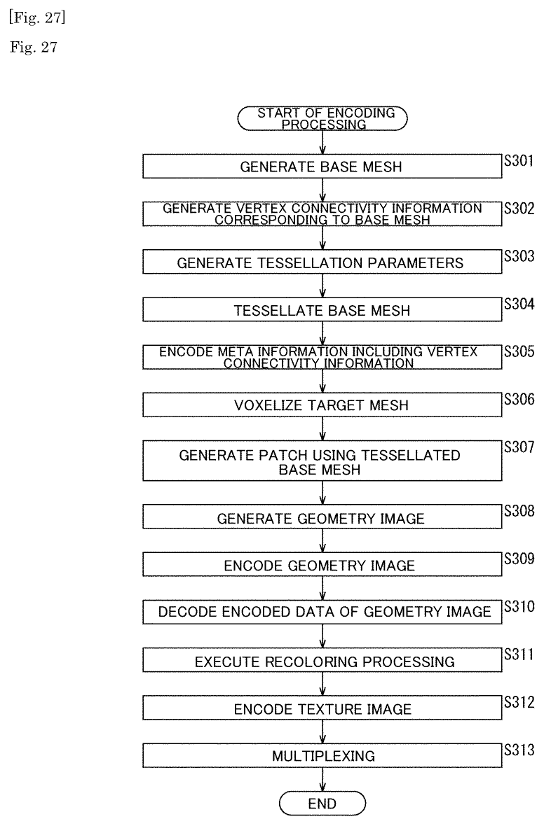

An example of the flow of the encoding processing executed by the encoding device 300 will be described with reference to the flowchart in FIG. 27.

When the encoding processing starts, the base mesh generation unit 311 generates a base mesh in step S301. In step S302, the base mesh generation unit 311 generates vertex connectivity information corresponding to the base mesh. The processing in step S301 and the processing in step S302 may be performed as one kind of processing.

In step S303, the tessellation parameter generation unit 312 generates tessellation parameters.

In step S304, the tessellation unit 313 tessellates the base mesh using the tessellation parameters.

In step S305, the meta information encoding unit 314 encodes meta information including vertex connectivity information corresponding to the base mesh and generates encoded data of the meta information.

In step S306, the mesh voxelization unit 315 voxelizes the target mesh 350 by converting the coordinates of vertices included in the vertex information 352 of the target mesh 350 into a voxel grid.

In step S307, the patch generation unit 316 generates a patch (patch image) using the base mesh tessellated by the processing in step S304.

In step S308, the image generation unit 317 arranges the patch on a two-dimensional plane to generate a geometry image.

In step S309, the 2D encoding unit 318 encodes that geometry image according to an encoding method for two-dimensional images and generates encoded data of the geometry image.

In step S310, the 2D decoding unit 319 decodes the encoded data of the geometry image according to a decoding method for two-dimensional images to generate (restore) the geometry image.

In step S311, the recoloring unit 320 performs texture image recoloring processing using the restored geometry image.

In step S312, the 2D encoding unit 321 encodes the recolored texture image and generates encoded data of the texture image.

In step S313, the multiplexing unit 322 multiplexes the encoded data of meta information, the tessellation parameters, the encoded data of the geometry image, and the encoded data of the texture image, and generates a single bit stream. The multiplexing unit 322 provides the generated bit stream to an external device. In other words, the multiplexing unit 322 provides the encoded data of meta information, the tessellation parameters, the encoded data of the geometry image, and the encoded data of the texture image.

When the processing in step S313 ends, the encoding processing ends.

Similarly to the case of applying the present technology to the encoding device 300, the present technology described in connection with <3. Mesh compression using base mesh> may be applied in the encoding processing.

For example, an encoding method may include generating a base mesh, which is 3D data representing a three-dimensional structure of an object by vertices and connections and has fewer vertices than a target mesh, generating multiple patches by dividing the target mesh and projecting the divided parts onto the base mesh, arranging the patches on a frame image to generate a geometry image, encoding meta information including vertex connectivity information about the vertices and connections of the base mesh, and encoding the geometry image. Other aspects of the present technology may also be applied similarly to the case of the encoding device 300.

Therefore, by applying the present technology as appropriate and executing each kind of processing, the encoding device 300 can achieve the advantageous effects described in connection with <3. Mesh compression using base mesh> More specifically, the encoding device 300 can suppress the reduction in the encoding efficiency while suppressing the degradation of the subjective image quality.

### 5. Second Embodiment

### <Decoding Device>

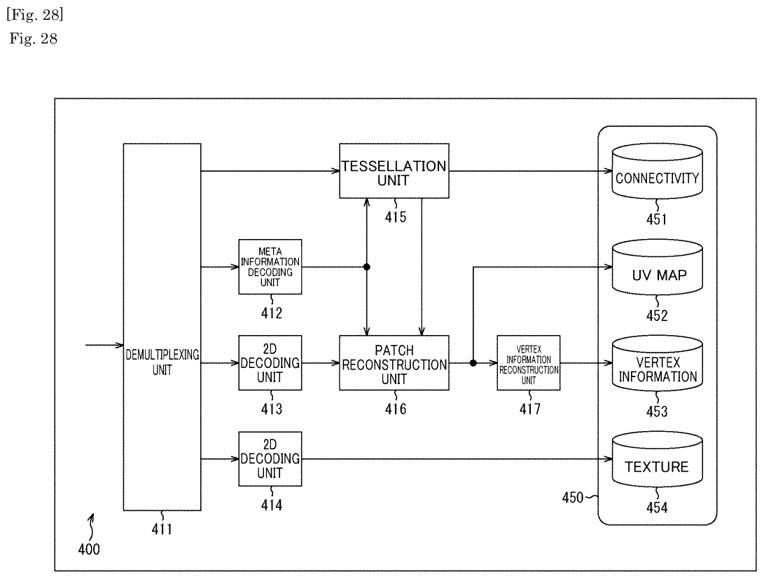

The present technology can also be applied to a decoding device 400, for example, as shown in FIG. 28. FIG. 28 is a block diagram of an exemplary configuration of the decoding device, which is a type of an image processing device to which the present technology is applied. The decoding device 400 shown in FIG. 28 decodes encoded data, which is encoded by an encoding method for two-dimensional images using 3D data with meshes as video frames according to an extension of VPCC, using a decoding method for two-dimensional images, and generates (reconstructs) 3D data with meshes.

Note that FIG. 28 illustrates principal components such as processing units and data flows, and FIG. 28 does not show all components. More specifically the decoding device 400 may include processing units that are not illustrated as blocks in FIG. 28, and there may be processing and data flows that are not illustrated as arrows or the like in FIG. 28.

As shown in FIG. 28, the decoding device 400 has a demultiplexing unit 411, a meta information decoding unit 412, a 2D decoding unit 413, a 2D decoding unit 414, a tessellation unit 415, a patch reconstruction unit 416, and a vertex information reconstruction unit 417.

The demultiplexing unit 411 performs processing related to demultiplexing, which separates multiplexed data. The demultiplexing unit 411 obtains a bit stream input to the decoding device 400. The bit stream is generated by the encoding device 300, for example, as described above in the first embodiment, and is obtained by encoding 3D data with meshes by enlarging VPCC.

The demultiplexing unit 411 demultiplexes the bit stream and obtains (generates) encoded data that is included in the bit stream. For example, the demultiplexing unit 411 obtains the encoded data of the meta information, the tessellation parameters, the encoded data of the geometry image, and the encoded data of the texture image through the demultiplexing. Accordingly the demultiplexing unit 411 can also be considered as an obtaining unit.

The demultiplexing unit 411 supplies the tessellation parameters to the tessellation unit 415. The demultiplexing unit 411 supplies encoded data of meta information to the meta information decoding unit 412. The demultiplexing unit 411 supplies the encoded data of a geometry image to the 2D decoding unit 413. The demultiplexing unit 411 supplies the encoded data of a texture image to the 2D decoding unit 414.

The meta information decoding unit 412 performs processing related to decoding of the encoded data of meta information. For example, the meta information decoding unit 412 may obtain the encoded data of meta information supplied from the demultiplexing unit 411. The meta information decoding unit 412 may decode the encoded data of the meta information using a two-dimensional image decoding method, and generate (restore) the meta information. The meta information includes vertex connectivity information corresponding to the base mesh. The meta information decoding unit 412 may also provide the vertex connectivity information to the tessellation unit 415 and the patch reconstruction unit 416.

The 2D decoding unit 413 performs processing related to decoding of encoded data of a two-dimensional image (geometry image). In other words, the 2D decoding unit 413 can also be considered as a geometry image decoding unit. For example, the 2D decoding unit 413 may obtain encoded data of a geometry image supplied from the demultiplexing unit 411. The 2D decoding unit 413 may also decode the encoded data of the geometry image using a two-dimensional image decoding method to generate (restore) the geometry image. The 2D decoding unit 413 may also supply the generated geometry image to the patch reconstruction unit 416.

The 2D decoding unit 414 performs processing related to decoding of encoded data of a two-dimensional image (texture image). In other words, the 2D decoding unit 414 can also be considered as a texture image decoding unit. For example, the 2D decoding unit 414 may obtain encoded data of a texture image supplied from the demultiplexing unit 411. The 2D decoding unit 414 may also decode the encoded data of the texture image using a two-dimensional image decoding method, and generate (restore) the texture image. The 2D decoding unit 414 may also output the generated texture image as a texture 454 that makes up the reconstructed mesh 450, externally from the decoding device 400.

The tessellation unit 415 performs processing related to tessellation. For example, the tessellation unit 415 may obtain tessellation parameters supplied by the demultiplexing unit 411. The tessellation unit 415 may also obtain vertex connectivity information corresponding to a base mesh supplied by the meta information decoding unit 412. The tessellation unit 415 may tessellate that vertex connectivity information (i.e., the base mesh) to increase the number of vertices using the tessellation parameters. In other words, the tessellation unit 415 can also be considered as a vertex number increasing unit. The tessellation unit 415 may supply the base mesh (vertex connectivity information of the base mesh) with the increased number of vertices to the patch reconstruction unit 416. The tessellation unit 415 may also output the vertex connectivity information (connectivity) of the base mesh with increased number of vertices externally from the decoding device 400 as connectivity 451, which constitutes the reconstructed mesh 450.

The patch reconstruction unit 416 performs processing related to patch reconstruction. For example, the patch reconstruction unit 416 may obtain vertex connectivity information (base mesh) supplied from the meta information decoding unit 412. The patch reconstruction unit 416 may also obtain a geometry image supplied from the 2D decoding unit 413. The patch reconstruction unit 416 may also obtain the base mesh (vertex connectivity information of the base mesh) with an increased number of vertices supplied from the tessellation unit 415. The patch reconstruction unit 416 may also reconstruct a patch (patch image) using those data. At the time, the patch reconstruction unit 416 may also generate a UV map, which indicates the two-dimensional coordinates (UV coordinates) of each vertex. The patch reconstruction unit 416 may also provide the reconstructed patch (patch image), the generated UV map, and meta information to the vertex information reconstruction unit 417. The patch reconstruction unit 416 may also output the generated UV map externally from the decoding device 400 as a UV map 452 that constitutes the reconstructed mesh 450.

The vertex information reconstruction unit 417 performs processing related to the reconstruction of vertex information about the vertices of the mesh. For example, the vertex information reconstruction unit 417 may obtain a patch, a UV map, or meta information provided by the patch reconstruction unit 416. The vertex information reconstruction unit 417 may also reconstruct the vertex information on the basis of the obtained information and restore the 3D coordinates of each vertex. The vertex information reconstruction unit 417 may output the reconstructed vertex information externally from the decoding device 400 as vertex information 453 that constitutes the reconstructed mesh 450.

The present technology described in connection with <3. Mesh compression using base mesh> may be applied to the decoding device 400 having the above-described configuration.

For example, in the decoding device 400, the meta information decoding unit 412 may decode encoded data of meta information including vertex connectivity information, which is information about vertices and connections of a base mesh, and the 2D decoding unit 413 may decode encoded data of a geometry image, which is a frame image on which a patch is arranged, the tessellation unit 415 increases the number of vertices of the base mesh using the vertex connectivity information, the patch reconstruction unit may reconstruct a patch using the geometry image and the base mesh with the increased number of vertices, and the vertex information reconstruction unit may reconstruct the three-dimensional positions of the vertices of the base mesh with the increased number of vertices using the reconstructed patch.

The vertex connectivity information may include base mesh vertex information about the vertices of the base mesh and base mesh connectivity information about the connections of the base mesh.

The vertex connectivity information may include the identification information of the prepared base mesh primitive, and the meta information decoding unit 412 may use the base mesh primitive corresponding to the identification information to generate the base mesh vertex information about the vertices of the base mesh and the base mesh connection information.

The meta information decoding unit 412 may also generate base mesh vertex information and base mesh connectivity information by enlarging, reducing, rotating, or moving the entire base mesh primitive.

The vertex connectivity information may further include parameters that are applied to the base mesh primitives, and the meta information decoding unit may use those parameters to enlarge, reduce, rotate, or move the entire base mesh primitive.

The parameters may also include parameters applied in affine transformation of that base mesh primitive.

The meta information decoding unit 412 may also generate base mesh vertex information and base mesh connectivity information by moving, increasing, or reducing, vertices of the base mesh primitive.

The vertex connectivity information may include identification information about another frame, and the meta information decoding unit 412 may refer to the base mesh vertex connectivity information about the base mesh vertices and the base mesh connectivity information about the base mesh connections corresponding to the other frame indicated by the identification information to determine the base mesh vertex information and base mesh connectivity information corresponding to the current frame.

In this case, the identification information may be the serial number of the frame in the sequence or may be the number of frames between the frame that is the reference source (i.e., the current frame) and the frame that is the reference destination.

The vertex connectivity information may include information about the vertices and connections for each of the multiple base meshes corresponding to one frame of the target mesh.

The vertex number increasing unit may also increase the number of vertices by splitting the polygons of the base mesh.

The tessellation unit 415 may also divide the polygon using a tessellation parameter. The tessellation parameters may include a tessellation level for the boundary edges of a patch and a tessellation level for the interior of the patch.

The tessellation parameters may include an initial value, identification information of the polygons whose values are to be updated, and the updated values, and the tessellation unit 415 may apply the initial values to the tessellation parameters for all polygons in the base mesh, and then apply the updated values for the polygons specified by the identification information to the tessellation parameters, and the tessellation parameters may be updated using the updated values.

For example, the patch reconstruction unit 416 may reconstruct a patch by dividing the base mesh with an increased number of vertices into small regions and extracting the parts corresponding to the small regions from the geometry image. The small regions may be polygons of the base mesh. The patch reconstruction unit 416 may reconstruct the patch by extracting the pixel values corresponding to the vertices in the small regions from the geometry image.

The vertex information reconstruction unit 417 may generate reconstructed vertex information by arranging the vertices in positions vertically away from the small regions by the distance indicated by the pixel values in the small regions. The vertex information reconstruction unit 417 may generate the reconstructed vertex information by arranging the vertices in positions away from the small regions along any of the three-dimensional coordinate axes by a distance indicated by pixel values. The vertex information reconstruction unit 417 may also calculate the offset of the small region with respect to a plane perpendicular to any of the three-dimensional coordinate axes and arrange the vertices using the offset.

In this way, the decoding device 400 can achieve the advantageous effects described in connection with <3. Mesh compression using base mesh>. That is, the decoding device 400 can suppress the reduction in the encoding efficiency while suppressing the degradation of the subjective image quality.

These processing units (the demultiplexing unit 411 to the vertex information reconstruction unit 417) have any configurations. For example, the processing units may be configured as logic circuits for realizing the above-describe kinds of processing. Each of the processing units may include, for example, a CPU, a ROM, and a RAM or the like and may implement the foregoing processing by executing a program using the CPU, the ROM, and the RAM or the like. It goes without saying that each of the processing units may have both of the aforementioned configurations, a part of the processing may be implemented by a logic circuit, and the other part of the processing may be implemented by executing a program. The processing units may have independent configurations, for example, some processing units may realize parts of the aforementioned processing according to a logic circuit, some other processing units may realize the aforementioned processing by executing a program, and some other processing units may realize the aforementioned processing according to both a logic circuit and execution of a program.

### <Flow of Decoding Processing>

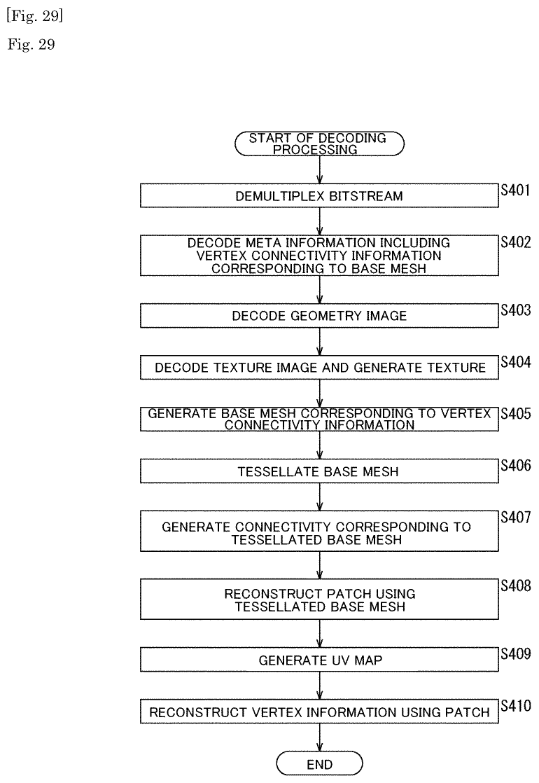

The flow of decoding processing executed by the decoding device 400 will be described with reference to the flowchart in FIG. 29.

When the decoding processing starts, in step S401, the demultiplexing unit 411 demultiplexes a bit stream input to the decoding device 400.

In step S402, the meta information decoding unit 412 decodes encoded data of meta information including vertex connectivity information corresponding to a base mesh.

In step S403, the 2D decoding unit 413 decodes encoded data of a geometry image.

In step S404, the 2D decoding unit 414 decodes encoded data of a video frame.

In step S405, the meta information decoding unit 412 generates a base mesh corresponding to the vertex connectivity information obtained in step S403.

In step S406, the tessellation unit 415 tessellates the base mesh obtained by the processing in step S405 and increases the number of vertices.

In step S407, the tessellation unit 415 generates connectivity information (connectivity) corresponding to the base mesh tessellated by the processing in step S406 (base mesh with the increased number of vertices).

In step S408, the patch reconstruction unit 416 reconstructs the patch using the base mesh tessellated by the processing in step S406 (base mesh with the increased number of vertices).

In step S409, the patch reconstruction unit 416 reconstructs a UV map indicating the two-dimensional coordinates (UV coordinates) of each vertex of the tessellated base mesh (base mesh with the increased number of vertices).

In step S410, the vertex information reconstruction unit 417 reconstructs vertex information that indicates the 3D coordinates of each vertex of the tessellated base mesh (base mesh with the increased number of vertices) using the patch reconstructed by the processing in step S408.

When the processing in step S410 ends, the decoding processing ends.

The present technology described in connection with <3. Mesh compression using base mesh> may be applied in the decoding processing similarly to the case of the decoding device 400.

For example, a decoding method may include decoding encoded data of meta information including vertex connectivity information, which is information about the vertices and connections of a base mesh, decoding encoded data of a geometry image, which is a frame image having a patch arranged thereon, increasing the number of vertices of the base mesh using the vertex connectivity information, reconstructing the patch using the geometry image and the base mesh with the increased number of vertices, and generating reconstructed vertex information about the vertices of the base mesh with the increased number of vertices by reconstructing the three-dimensional positions of the vertices of the base mesh with the increased number of vertices using the reconstructed patch. Similarly to the case of the decoding device 400, any of the other features of the present technology may be applied.

Therefore, by applying the present technology as appropriate to execute various kinds of processing, the decoding device 400 can achieve the advantageous effects described in connection with <3. Mesh compression using base mesh>. That is, the decoding device 400 can suppress the reduction in the encoding efficiency while suppressing the degradation of the subjective image quality.

### 6. Supplement

### Application Examples

In the above description, the position of the geometry in the geometry image and the position of the texture in the texture image are identical to each other, but these positions do not have to be identical to each other. In that case, a UV map that indicates the correspondence between the geometry image and the texture image may be transmitted from the encoding side to the decoding side.

In the above description, the base mesh (corresponding vertex connectivity information) is transmitted from the encoding side to the decoding side, but the vertex connectivity information may be divided for each patch, and transmitted as patch-by-patch information.

In the above description, the base mesh has a lower resolution than the target mesh (i.e., has fewer vertices and connections), but the number of vertices and the number of connections may be identical between the base mesh and the target mesh. In other words, the target mesh (corresponding vertex connectivity information) may be transmitted from the encoding side to the decoding side. In this case, processing such as tessellation may be unnecessary at the decoder.

The number of vertices and the number of connections may be identical between the base mesh and the target mesh, and the vertex connectivity information corresponding to the base mesh may be divided for each patch and transmitted as patch-by-patch information.

In the above description, the base mesh is used as the projection plane, but the target mesh may be projected onto the six planes without being projected onto the base mesh. Furthermore, the number of vertices and the number of connections may be identical between the base mesh and the target mesh.

### <Encoding Method>

In the above description, 3D data using a mesh is encoded by extending the VPCC standard, but V3C (Visual Volumetric Video-based Coding) or MIV (Metadata Immersive Video) may also be applied instead of VPCC. V3C and MIV are standards that use encoding techniques similar to VPCC and can be extended to encode 3D data using a mesh in the same way as VPCC. Therefore, when applying V3C or MIV to encode 3D data using a mesh, the above-described present technology can also be applied.

### <3D Data>

In the foregoing description, the present technology is applied in encoding/decoding of meshes, but the present technology is not limited to the examples and can be applied in encoding/decoding of 3D data in any standard. That is, various types of processing such as encoding/decoding methods, and specifications of various types of data such as 3D data and meta data may be arbitrary as long as there is no contradiction with the above-described present technology. In addition, as long as there is no contradiction with the present technology, some of the aforementioned processing steps and specifications may be omitted.

### <Computer>

The above-described series of processing can be executed by hardware or software. When the series of processing is executed by software, a program that constitutes the software is installed on a computer. Here, the computer includes, for example, a computer built in dedicated hardware and a general-purpose personal computer on which various programs are installed to be able to execute various functions.

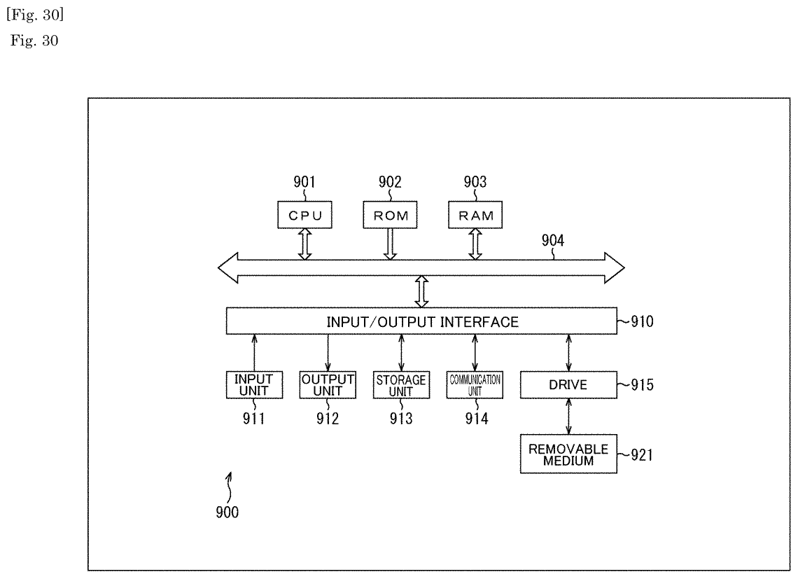

FIG. 30 is a block diagram showing an example of a hardware configuration of a computer that executes the above-described series of processing according to a program.

In a computer 900 illustrated in FIG. 30, a central processing unit (CPU) 901, a read only memory (ROM) 902, and a random access memory (RAM) 903 are connected to one another via a bus 904.

An input/output interface 910 is also connected to the bus 904. An input unit 911, an output unit 912, a storage unit 913, a communication unit 914, and a drive 915 are connected to the input/output interface 910.

The input unit 911 is, for example, a keyboard, a mouse, a microphone, a touch panel, or an input terminal. The output unit 912 is, for example, a display a speaker, or an output terminal. The storage unit 913 includes, for example, a hard disk, a RAM disk, and non-volatile memory. The communication unit 914 includes, for example, a network interface. The drive 915 drives a removable medium 921 such as a magnetic disk, an optical disc, a magneto-optical disk, or a semiconductor memory.

In the computer configured as described above, the CPU 901 loads a program stored in the storage unit 913 into the RAM 903 via the input/output interface 910 and the bus 904 and executes the program, so that the series of processing is performed. Data and the like necessary for the CPU 901 to execute the various kinds of processing is also stored as appropriate in the RAM 903.

The program executed by the computer can be recorded in, for example, the removable medium 921 as a package medium or the like and provided in such a form. In such a case, the program can be installed in the storage unit 913 via the input/output interface 910 by inserting the removable medium 921 into the drive 915.

This program can also be provided via wired or wireless transfer medium such as a local area network, the Internet, and digital satellite broadcasting. In such a case, the program can be received by the communication unit 914 and installed in the storage unit 913.

In addition, this program can be installed in advance in the ROM 902, the storage unit 913, or the like.

### <Application Target of Present Technology>

The present technology can be applied to any desired configuration. For example, the present technology can be applied to a variety of electronic devices.

In addition, for example, the present technology can be implemented as a configuration of a part of a device such as a processor (e.g., a video processor) of a system large scale integration (LSI) circuit, a module (e.g., a video module) using a plurality of processors or the like, a unit (e.g., a video unit) using a plurality of modules or the like, or a set (e.g., a video set) with other functions added to the unit.

For example, the present technology can also be applied to a network system configured with a plurality of devices. The present technology may be implemented as, for example, cloud computing for processing shared among a plurality of devices via a network. For example, the present technology may be implemented in a cloud service that provides services regarding images (moving images) to any terminals such as a computer, an audio visual (AV) device, a mobile information processing terminal, and an Internet-of-Things (IoT) device or the like.

In the present specification, a system means a set of a plurality of constituent elements (devices, modules (parts), or the like) and all the constituent elements may not be in the same casing. Accordingly a plurality of devices accommodated in separate casings and connected via a network and a single device accommodating a plurality of modules in a single casing are all a system.

<Fields and Applications to which Present Technology is Applicable>

A system, device, a processing unit, and the like to which the present technology is applied can be used in any field such as traffic, medical treatment, security agriculture, livestock industries, a mining industry beauty factories, home appliance, weather, and natural surveillance, for example. Any purpose can be set.

### <Others>

Note that “flag” in the present specification is information for identifying a plurality of states and includes not only information used to identify two states of true (1) or false (0) but also information that allows identification of three or more states. Therefore, a value that can be indicated by “flag” may be, for example, a binary value of 1 or 0 or may be ternary or larger. In other words, the number of bits constituting “flag” may be any number, e.g., 1 bit or a plurality of bits. It is also assumed that the identification information (also including a flag) is included in a bit stream or the difference information of identification information with respect to certain reference information is included in a bit stream. Thus, “flag” and “identification information” in the present specification include not only the information but also the difference information with respect to the reference information.

Various kinds of information (such as meta data) related to encoded data (bit stream) may be transmitted or recorded in any form as long as the information is associated with encoded data. For example, the term “associate” means that when one data is processed, the other may be used (may be associated). In other words, mutually associated items of data may be integrated into one item of data or may be individual items of data. For example, information associated with encoded data (image) may be transmitted through a transmission path that is different from that for the encoded data (image). For example, the information associated with the encoded data (image) may be recorded in a recording medium that is different from that for the encoded data (image) (or a different recording area in the same recording medium). “Associate” may correspond to part of data instead of the entire data. For example, an image and information corresponding to the image may be associated with a plurality of frames, one frame, or any unit such as a part in the frame.

Meanwhile, in the present specification, terms such as “synthesize”, “multiplex”, “add”, “integrate”, “include”, “store”, “put in”, “enclose”, and “insert” may mean, for example, combining a plurality of objects into one, such as combining encoded data and meta data into one piece of data, and means one method of “associating” described above.

Embodiments of the present technology are not limited to the above-described embodiments and can be changed variously within the scope of the present technology without departing from the gist of the present technology.

For example, a configuration described as one device (or processing unit) may be split into and configured as a plurality of devices (or processing units). Conversely configurations described above as a plurality of devices (or processing units) may be integrated and configured as one device (or processing unit). It is a matter of course that configurations other than the aforementioned configurations may be added to the configuration of each device (or each processing unit). Moreover, some of configurations of a certain device (or processing unit) may be included in a configuration of another device (or another processing unit) as long as the configurations and operations of the overall system are substantially identical to one another.

For example, the aforementioned program may be executed by any device. In this case, the device only needs to have necessary functions (such as functional blocks) to obtain necessary information.

Further, for example, each step of one flowchart may be executed by one device, or may be shared and executed by a plurality of devices. Further, when a plurality of processing is included in one step, one device may execute the plurality of processing, or the plurality of devices may share and execute the plurality of processing. In other words, it is also possible to execute the plurality of processing included in one step as processing of a plurality of steps. Conversely it is also possible to execute processing described as a plurality of steps collectively as one step.

Further, for example, in a program that is executed by a computer, processing of steps describing the program may be executed in time series in an order described in the present specification, or may be executed in parallel or individually at a required timing such as when call is made. That is, the processing of the respective steps may be executed in an order different from the above-described order as long as there is no contradiction. Further, the processing of the steps describing this program may be executed in parallel with processing of another program, or may be executed in combination with the processing of the other program.

Further, for example, a plurality of technologies regarding the present technology can be independently implemented as a single body as long as there is no contradiction. Of course, it is also possible to perform any plurality of the present technologies in combination. For example, it is also possible to implement some or all of the present technologies described in any of the embodiments in combination with some or all of the technologies described in other embodiments. Further, it is also possible to implement some or all of any of the above-described technologies in combination with other technologies not described above.

The present technology can also be configured as follows.

(1) An information processing device including:
a base mesh generation unit configured to generate a base mesh which is 3D data that represents a three-dimensional structure of an object by vertices and connections and has a smaller number of the vertices than a target mesh;
a patch generation unit configured to generate a plurality of patches by dividing the target mesh and projecting the divided parts on the base mesh;
a geometry image generation unit configured to generate a geometry image by arranging the patches on a frame image;
a meta information encoding unit configured to encode meta information including vertex connectivity information about the vertices and the connections of the base mesh; and
a geometry image encoding unit configured to encode the geometry image.

(2) The information processing device according to (1), wherein the base mesh generation unit generates the base mesh by decimating the target mesh.

(3) The information processing device according to (2), wherein the base mesh generation unit generates the base mesh by deforming the decimated target mesh.

(4) The information processing device according to (2) or (3), wherein the vertex connectivity information includes vertex information about the vertices of the base mesh and connectivity information about the connections of the base mesh.

(5) The information processing device according to any one of (1) to (4), wherein the base mesh generation unit generates the base mesh using a mesh model prepared in advance.

(6) The information processing device according to (5), wherein the vertex connectivity information includes identification information of the base mesh applied to generation of the base mesh.

(7) The information processing device according to (6), wherein the vertex connectivity information further includes a parameter applied to the mesh model.

(8) The information processing device according to (7), wherein the parameter includes a parameter applied in affine transformation of the mesh model.

(9) The information processing device according to any one of (5) to (8), wherein the base mesh generation unit generates the base mesh by deforming the mesh model.

(10) The information processing device according to (9), wherein the base mesh generation unit generates the base mesh by enlarging, reducing, rotating, or moving the entire mesh model.

(11) The information processing device according to (9) or (10), wherein the base mesh generation unit generates the base mesh by moving, increasing, or reducing the vertices of the mesh model.

(12) The information processing device according to any one of (1) to (11), wherein the base mesh generation unit generates the base mesh for each frame of the target mesh.

(13) The information processing device according to (12), wherein the base mesh generation unit generates a plurality of the base meshes for one frame of the target mesh.

(14) The information processing device according to any one of (1) to (13), wherein the base mesh generation unit generates the base mesh common among a plurality of frames of the target mesh.

(15) The information processing device according to (14), wherein the vertex connectivity information about the frame that references the base mesh of a further frame includes identification information about the further frame.

(16) The information processing device according to (15), wherein the identification information is the serial number of the frame in a sequence.

(17) The information processing device according to (15), wherein the identification information is the number of frames between the frame that is the reference source and the frame that is the reference destination.

(18) The information processing device according to any one of (1) to (17), further including a vertex number increasing unit configured to increase the number of vertices of the base mesh, wherein the patch generation unit generates a plurality of the patches by projecting the divided parts of the target mesh on the base mesh with the increased number of vertices.

(19) The information processing device according to (18), wherein the vertex number increasing unit increases the number of vertices by dividing a polygon of the base mesh.

(20) The information processing device according to (19), further including a tessellation parameter generation unit configured to generate a tessellation parameter applied to the division of the polygon.

(21) The information processing device according to (20), wherein the tessellation parameters include a tessellation level for the boundary edges of a patch and a tessellation level for the inside of the patch.

(22) The information processing device according to (21), wherein the tessellation parameters include an initial value, identification information of the polygon whose value is to be updated, and the updated value.

(23) The information processing device according to any one of (18) to (22), wherein the patch generation unit divides the target mesh into units of small regions projected onto identical polygons of the base mesh.

(24) The information processing device according to any one of (18) to (23), wherein the patch generation unit calculates the difference in position between each of the vertices of the base mesh with the increased number of vertices and the target mesh.

(25) The information processing device according to (24), wherein the patch generation unit calculates the difference for the vertical direction of the surface of the base mesh.

(26) The information processing device according to (24), wherein the patch generation unit calculates the difference along any of the three-dimensional coordinate axes.

(27) An information processing method including the steps of:
generating a base mesh which is 3D data that represents a three-dimensional structure of an object by vertices and connections and has a smaller number of the vertices than a target mesh;
generating a plurality of patches by dividing the target mesh and projecting the divided parts on the base mesh;
generating a geometry image by arranging the patches on a frame image; encoding meta information including vertex connectivity information about the vertices and the connections of the base mesh; and encoding the geometry image.

(41) An information processing device including:
a meta information decoding unit configured to decode encoded data of meta information including vertex connectivity information which is information about vertices and connections of a base mesh;
a geometry image decoding unit configured to decode encoded data of a geometry image which is a frame image having a patch arranged thereon,
a vertex number increasing unit configured to increase the number of vertices of the base mesh using the vertex connectivity information;
a patch reconstruction unit configured to reconstruct the patch using the geometry image and the base mesh with the increased number of vertices; and
a vertex information reconstruction unit configured to generate reconstructed vertex information about the vertices of the base mesh with the increased number of vertices by reconstructing three-dimensional positions of the vertices of the base mesh with the increased number of vertices using the reconstructed patch;
wherein
the base mesh is 3D data that represents a three-dimensional structure of an object by the vertices and the connections and has a smaller number of the vertices than a target mesh, and
the patch is a divided part of the target mesh that represents the base mesh as a projection plane.

(42) The information processing device according to (41), wherein the vertex connectivity information includes base mesh vertex information about the vertices of the base mesh and base mesh connectivity information about the connections of the base mesh.

(43) The information processing device according to (41) or (42), wherein the vertex connectivity information includes identification information about a mesh model prepared in advance, and the meta information decoding unit generates base mesh vertex information about the vertices of the base mesh and base mesh connectivity information about the connections of the base mesh using the mesh model corresponding to the identification information.

(44) The information processing device according to (43), wherein the meta information decoding unit generates the base mesh vertex information and the base mesh connectivity information by enlarging, reducing, rotating or moving the entire mesh model.

(45) The information processing device according to (44), wherein the vertex connectivity information includes parameters applied to the mesh model, and the meta information decoding unit enlarges, reduces, rotates, or moves the entire mesh model by applying the parameters.

(46) The information processing device according to (45), wherein the parameters include parameters applied in affine transformation of the mesh model.

(47) The information processing device according to any one of (43) to (46), wherein the meta information decoding unit generates the base mesh vertex information the base mesh connectivity information by moving, increasing or reducing the vertices of the mesh model.

(48) The information processing device according to any one of (41) to (47), wherein the vertex connectivity information includes identification information about a further frame, and
the meta information decoding unit refers to the base mesh vertex information about the vertices of the base mesh and the base mesh connectivity information about the connections of the base mesh corresponding to the further frame and determines these kinds of information as the base mesh vertex information and the base mesh connectivity information corresponding to a current frame.

(49) The information processing device according to (48), wherein the identification information is the serial number of the frame in a sequence.

(50) The information processing device according to (48), wherein the identification information is the number of frames between the frame that is the reference source and the frame that is the reference destination.

(51) The information processing device according to any one of (41) to (51), wherein the vertex connectivity information includes information about the vertices and connections for each of multiple base meshes corresponding to one frame of the target mesh.

(52) The information processing device according to any one of (41) to (51), wherein the vertex number increasing unit increases the number of vertices by dividing the polygons of the base mesh.

(53) The information processing device according to (52), wherein the vertex number increasing unit divides the polygon using a tessellation parameter.

(54) The information processing device according to (53), wherein the tessellation parameters include a tessellation level for the boundary edges of the patch and a tessellation level for the inside of the patch.

(55) The information processing device according to (53) or (54), wherein the tessellation parameters include an initial value, identification information about the polygon whose value is to be updated, and the updated value,
the vertex number increasing unit applies the initial value to the tessellation parameters for all polygons in the base mesh, and updates the tessellation parameters for the polygon specified by the identification information using the updated value.

(56) The information processing device according to any one of (41) to (55), wherein the patch reconstruction unit reconstructs the patch by dividing the base mesh with the increased number of vertices for each small region and reconstructs the patch by extracting a part corresponding to the small region from the geometry image.

(57) The information processing device according to (56), wherein the small region is a polygon of the base mesh.

(58) The information processing device according to (56) or (57), wherein the patch reconstruction unit reconstructs the patch by extracting a pixel value corresponding to the vertex in the small region in the geometry image.

(59) The information processing device according to (58), wherein the vertex information reconstruction unit generates the reconstructed vertex information by arranging the vertex in a position vertically away from the small region by a distance indicated by the pixel value.

(60) The information processing device according to (58), wherein the vertex information reconstruction unit generates the reconstructed vertex information by arranging the vertex in a position away from the small region by a distance indicated by the pixel value along any of three-dimensional coordinate axes.

(61) The information processing device according to (60), wherein the vertex information reconstruction unit calculates an offset of the small region with respect to a plane perpendicular to any of the three-dimensional coordinate axes and arranges the vertex using the offset.

(62) An information processing method including the steps of:
decoding encoded data of meta information including vertex connectivity information which is information about vertices and connections of a base mesh;
decoding encoded data of a geometry image which is a frame image having a patch arranged thereon, increasing the number of vertices of the base mesh using the vertex connectivity information;
reconstructing the patch using the geometry image and the base mesh with the increased number of vertices;
generating reconstructed vertex information about the vertices of the base mesh with the increased number of vertices by reconstructing three-dimensional positions of the vertices of the base mesh with the increased number of vertices using the reconstructed patch,
wherein the base mesh is 3D data that represents a three-dimensional structure of an object by the vertices and the connections and has a smaller number of the vertices than a target mesh, and
the patch is a divided part of the target mesh that represents the base mesh as a projection plane.

### REFERENCE SIGNS LIST

300 Encoding unit
311 Base mesh generation unit
312 Tessellation parameter generation unit
313 Tessellation unit
314 Meta information encoding unit
315 Mesh voxelization unit
316 Patch generation unit
317 Image generation unit
318 2D encoding unit
319 2D decoding unit
320 Recoloring unit
321 2D encoding unit
322 Demultiplexing unit
400 Decoding unit
411 Demultiplexing unit
412 Meta information decoding unit
413, 414 2D decoding unit
415 Tessellation unit
416 Patch reconstruction unit
417 Vertex information reconstruction unit
900 Computer

1. An information processing device comprising:
a base mesh generation unit configured to generate a base mesh which is 3D data that represents a three-dimensional structure of an object by vertices and connections and has a smaller number of the vertices than a target mesh;
a patch generation unit configured to generate a plurality of patches by dividing the target mesh and projecting the divided parts on the base mesh;
a geometry image generation unit configured to generate a geometry image by arranging the patches on a frame image;
a meta information encoding unit configured to encode meta information including vertex connectivity information about the vertices and the connections of the base mesh; and
a geometry image encoding unit configured to encode the geometry image.

2. The information processing device according to claim 1, wherein the base mesh generation unit generates the base mesh by decimating the target mesh.

3. The information processing device according to claim 2, wherein the base mesh generation unit generates the base mesh by deforming the decimated target mesh.

4. The information processing device according to claim 1, wherein the base mesh generation unit generates the base mesh using a mesh model prepared in advance.

5. The information processing device according to claim 4, wherein the base mesh generation unit generates the base mesh by deforming the mesh model.

6. The information processing device according to claim 1, wherein the base mesh generation unit generates the base mesh common among a plurality of frames of the target mesh.

7. The information processing device according to claim 1, further comprising a vertex number increasing unit configured to increase the number of vertices of the base mesh, wherein
the patch generation unit generates a plurality of the patches by projecting the divided parts of the target mesh on the base mesh with the increased number of vertices.

8. The information processing device according to claim 7, wherein the vertex number increasing unit increases the number of vertices by dividing a polygon of the base mesh.

9. The information processing device according to claim 7, wherein the patch generation unit calculates difference in position between each of the vertices of the base mesh with the increased number of vertices and the target mesh.

10. An information processing method comprising the steps of generating a base mesh which is 3D data that represents a three-dimensional structure of an object by vertices and connections and has a smaller number of the vertices than a target mesh;
generating a plurality of patches by dividing the target mesh and projecting the divided parts on the base mesh;
generating a geometry image by arranging the patches on a frame image;
encoding meta information including vertex connectivity information about the vertices and the connections of the base mesh; and
encoding the geometry image.

11. An information processing device comprising:
a meta information decoding unit configured to decode encoded data of meta information including vertex connectivity information which is information about vertices and connections of a base mesh;
a geometry image decoding unit configured to decode encoded data of a geometry image which is a frame image having a patch arranged thereon,
a vertex number increasing unit configured to increase the number of vertices of the base mesh using the vertex connectivity information;
a patch reconstruction unit configured to reconstruct the patch using the geometry image and the base mesh with the increased number of vertices;
a vertex information reconstruction unit configured to generate reconstructed vertex information about the vertices of the base mesh with the increased number of vertices by reconstructing three-dimensional positions of the vertices of the base mesh with the increased number of vertices using the reconstructed patch;
wherein
the base mesh is 3D data that represents a three-dimensional structure of an object by the vertices and the connections and has a smaller number of the vertices than a target mesh, and
the patch is a divided part of the target mesh that represents the base mesh as a projection plane.

12. The information processing device according to claim 11, wherein the vertex connectivity information includes identification information about a mesh model prepared in advance, and
the meta information decoding unit generates base mesh vertex information about the vertices of the base mesh and base mesh connectivity information about the connections of the base mesh using the mesh model corresponding to the identification information.

13. The information processing device according to claim 12, wherein the meta information decoding unit generates the base mesh vertex information and the base mesh connectivity information by enlarging, reducing, rotating or moving the entire mesh model.

14. The information processing device according to claim 12, wherein the meta information decoding unit generates the base mesh vertex information and the base mesh connectivity information by moving, increasing or reducing the vertices of the mesh model.

15. The information processing device according to claim 11, wherein the vertex connectivity information includes identification information about a further frame,
the meta information decoding unit refers to the base mesh vertex information about the vertices of the base mesh and the base mesh connectivity information about the connections of the base mesh corresponding to the further frame and determines these kinds of information as the base mesh vertex information and the base mesh connectivity information corresponding to a current frame.

16. The information processing device according to claim 11, wherein the vertex number increasing unit increases the number of vertices by dividing a polygon of the base mesh.

17. The information processing device according to claim 11, wherein the patch reconstruction unit reconstructs the patch by extracting a pixel value corresponding to the vertex in a small region in the geometry image.

18. The information processing device according to claim 17, wherein the vertex information reconstruction unit generates the reconstructed vertex information by arranging the vertex in a position away from the small region by a distance indicated by the pixel value along any of three-dimensional coordinate axes.

19. The information processing device according to claim 18, wherein the vertex information reconstruction unit calculates an offset of the small region with respect to a plane perpendicular to any of the three-dimensional coordinate axes and arranges the vertex using the offset.

20. An information processing method comprising the steps of decoding encoded data of meta information including vertex connectivity information about vertices and connections of a base mesh;
decoding encoded data of a geometry image which is a frame image having a patch arranged thereon;
increasing the number of vertices of the base mesh using the vertex connectivity information;
reconstructing the patch using the geometry image and the base mesh having the increased number of the vertices; and
generating reconstructed vertex information about the vertices of the base mesh having the increased number of vertices by reconstructing three-dimensional positions of the vertices of the base mesh having the increased number of vertices using the reconstructed patch, wherein
the base mesh is 3D data that represents a three-dimensional structure of an object by the vertices and the connections and has a smaller number of the vertices than a target mesh, and
the patch is a divided part of the target mesh that represents the base mesh as a projection plane.
